(19) United States
(12) Patent Application Publication
(10) Pub. No.: US 2015/0222302 A1
(43) Pub. Date: Aug. 6, 2015

(54) INFORMATION PROCESSING SYSTEM AND PARAMETER ADJUSTMENT METHOD

(71) Applicant: FUJITSU LIMITED, Kawasaki-shi (JP)

(72) Inventor: Tokinobu IIDA, Sumida (JP)

(21) Appl. No.: 14/602,311

(22) Filed: Jan. 22, 2015

(30) Foreign Application Priority Data
Feb. 3, 2014 (JP) 2014-018915

(51) Int. Cl. H04B 1/04

(52) U.S. Cl. CPC H04B 1/0475

(57) ABSTRACT

An information processing system includes: a transmission device to generate a transmission signal on the basis of a pre-emphasis parameter; a reception device to generate reception data from the transmission signal on the basis of a clock signal; and a processor. The processor sets a center value, calculates and compares an eye diagram width of the center value and an eye diagram width of each peripheral value, when any of the eye diagram widths of the peripheral values is larger than the eye diagram width of the center value, repeats a process for setting as the center value a peripheral value that corresponds to a largest eye diagram width, a process for calculating the eye diagram width of each peripheral value and the comparing process until the eye diagram width of the center value becomes larger than the eye diagram width of each peripheral value.

### CROSS-REFERENCE TO RELATED APPLICATION

This application is based upon and claims the benefit of priority of the prior Japanese Patent Application No. 2014-018915, filed on Feb. 3, 2014, the entire contents of which are incorporated herein by reference.

### FIELD

The embodiments discussed herein are related to an information processing system and a parameter adjustment method.

### BACKGROUND

In recent serial communications, transfer signals are greatly influenced by attenuation and distortion due to speeding-up of transfer rates, and attenuation and distortion become causes for transfer errors.

As a result, signal adjustment is performed in advance on a transmission side in order to suppress attenuation and distortion. An example of such a signal adjustment technique is pre-emphasis.

Pre-emphasis is an electrical technique that is related to information transfer, and is a modulation technique for sending a transfer signal from a transmission side while amplifying a high pass side thereof according to attenuation characteristics at high frequencies that are unique to a transfer path, and improving frequency characteristics of a signal that is received at a reception side.

FIG. 1 is a diagram illustrating a transmission wave and a reception wave when pre-emphasis is not used.

An upper side of FIG. 1 depicts a transmission wave that is transmitted from a transmission device, and a lower side depicts a reception wave that is received by a reception device after passing through a transfer path.

As illustrated in FIG. 1, when the transmission wave is not adjusted by the transmission device, the reception wave that is received by the reception device is distorted due to attenuation of high-frequency components, and the possibility of errors increases.

FIG. 2 is a diagram illustrating a transmission wave and a reception wave when pre-emphasis is used.

An upper side of FIG. 2 depicts a transmission wave that is transmitted from the transmission device, and a lower side of FIG. 2 depicts a reception wave that is received by the reception device after passing through the transfer path.

The transmission wave in FIG. 2 is obtained by performing pre-emphasis on the transmission wave in FIG. 1.

As illustrated in FIG. 2, high-frequency components of the transmission wave on which pre-emphasis is performed are emphasized.

When a transmission wave whose high-frequency components are emphasized is received by a reception device, the waveform of a reception wave becomes that of a transmission wave that was originally intended to be transmitted by a transmission device, due to attenuation of the high-frequency components. As a result, the possibility of errors decreases.

The attenuation amount of high-frequency components fluctuates according to conditions such as a material of a transfer path and a path length. Therefore, in order to perform communication with few errors, a pre-emphasis parameter needs to be appropriately set according to these conditions.

When emphasis strength is the only pre-emphasis parameter, an optimum value can be determined by lowering a value step by step from the maximum value; however, when there are two or more pre-emphasis parameters, combinations of parameters that are measured increase exponentially.

For example, when there are six set values for one parameter, there are 36 (=6×6) set values for two parameters. Similarly, when there are three parameters, there are 216 (=6×6×6) set values. The number of parameters has tended to increase due to the speeding-up of transmission rates in recent years.

In a conventional method, there is a problem wherein much time is taken since an optimum value of parameters is determined by measuring a signal quality such as an eye diagram and an error rate for all combinations of parameters.

Furthermore, documents such as Japanese Laid-open Patent Publication No. 2008-177940, Japanese Laid-open Patent Publication No. 2011-205340, Japanese Laid-open Patent Publication No. 2011-41109, International Publication Pamphlet No. WO 2009/013790, etc. are well known.

### SUMMARY

According to an aspect of the invention, an information processing system of the embodiments includes a transmission device, a reception device, and a processor.

The transmission device generates a transmission signal by adjusting a signal for transmitting data on the basis of a pre-emphasis parameter, and transmits the transmission signal.

The reception device receives the transmission signal, generates reception data from the transmission signal on the basis of a clock signal, and counts the number of errors of the reception data.

The processor that adjusts the pre-emphasis parameter and adjusts a phase of the clock signal.

The processor sets a first center value as an initial value of the parameter.

The processor calculates an eye diagram width of the first center value, and calculates an eye diagram width of each peripheral value of a plurality of peripheral values.

The processor compares the eye diagram width of the first center value and the eye diagram width of each peripheral value. When any of the eye diagram widths of the peripheral values is larger than the eye diagram width of the first center value, the processor repeats a process for setting as the first center value a peripheral value that corresponds to a largest eye diagram width in the eye diagram widths of the peripheral values, a process for calculating the eye diagram width of each peripheral value, and the comparing process until the eye diagram width of the first center value becomes larger than the eye diagram width of each peripheral value.

When the eye diagram width of the first center value is larger than the eye diagram width of each peripheral value, the processor sets the parameter as the first center value, and sets the average value of the right end and the left end of the eye diagram width of the first center value as the phase.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a transmission wave and a reception wave when pre-emphasis is not used.

FIG. 2 is a diagram illustrating a transmission wave and a reception wave when pre-emphasis is used.

FIG. 3 is a configuration diagram of an information processing system according to the embodiments.

FIG. 4 is a diagram illustrating a bathtub curve.

FIG. 5 is a diagram illustrating a bathtub curve.

FIG. 6 is a diagram illustrating a left end of an eye width in a bathtub curve.

FIG. 7 is a diagram illustrating a right end of an eye width of a bathtub curve.

FIG. 8 is a diagram illustrating a bathtub curve.

FIG. 9 is a diagram illustrating a right end and a left end of an eye width of a bathtub curve.

FIG. 10 is a diagram illustrating a bathtub curve.

FIG. 11 is a diagram illustrating extension of peripheral values.

FIG. 12 is a diagram illustrating a right end and a left end of an eye width of a bathtub curve.

FIG. 13 is a diagram illustrating an initial value on a left side of error measurement in second and subsequent clock phase adjustment processes.

FIG. 14 is a diagram illustrating an initial value on a right side of error measurement in second and subsequent clock phase adjustment processes.

FIGS. 15A and 15B are a flowchart of a clock phase adjustment process.

FIG. 16 is a flowchart of a start position setting process.

FIG. 17 is a diagram illustrating measurement points.

FIG. 18 is a diagram illustrating measurement results.

FIG. 19 is a diagram illustrating comparison results.

FIG. 20 is a diagram illustrating an additional measurement point.

FIG. 21 is a diagram illustrating a result of additional measurement.

FIG. 22 is a diagram illustrating a new center value and measurement points.

FIG. 23 is a diagram illustrating an additional measurement point with respect to a new center value.

FIG. 24 is a diagram illustrating a result of additional measurement.

FIG. 25 is a diagram illustrating a new center value.

FIG. 26 is a diagram illustrating a new center value and measurement points.

FIG. 27 is a diagram illustrating results for additional measurement.

FIG. 28 is a diagram illustrating an additional measurement point with respect to a new center value.

FIG. 29 is a diagram illustrating a measurement result.

FIG. 30 is a diagram illustrating a first pattern of a comparison result for eye widths of peripheral values.

FIG. 31 is a diagram illustrating a second pattern of a comparison result for eye widths of peripheral values.

FIG. 32 is a diagram illustrating a third pattern of a comparison result for eye widths of peripheral values.

FIG. 33 is a diagram illustrating a fourth pattern of a comparison result for eye widths of peripheral values.

FIG. 34 is a diagram illustrating a comparison result when measurement results of peripheral values are the same.

FIG. 35 is a diagram illustrating additional measurement points when measurement results of peripheral values are the same.

FIG. 36 is a flowchart of a pre-emphasis adjustment process according to the embodiments.

FIG. 37 is a diagram illustrating set values of pre-emphasis whose eye widths are measured.

FIG. 38 is a diagram illustrating set values of pre-emphasis whose eye widths are measured.

FIG. 39 is a diagram illustrating initial measurement points of third-order parameters.

FIG. 40 is a diagram illustrating a determination result of third-order parameters.

FIG. 41 is a diagram illustrating an additional measurement point.

FIG. 42 is a diagram illustrating measurement points with respect to a new center value.

FIG. 43 is a diagram illustrating new measurement points when a determination result for one parameter is “equal”.

FIG. 44 is a diagram illustrating additional measurement points when determination results for two parameters are “equal”.

FIG. 45 is a diagram illustrating measurement points.

FIG. 46 is a diagram illustrating measurement points in which determination results are “large” or “equal”.

FIG. 47 is a diagram illustrating additional measurement points.

FIG. 48 is a configuration diagram of an information processing device (computer).

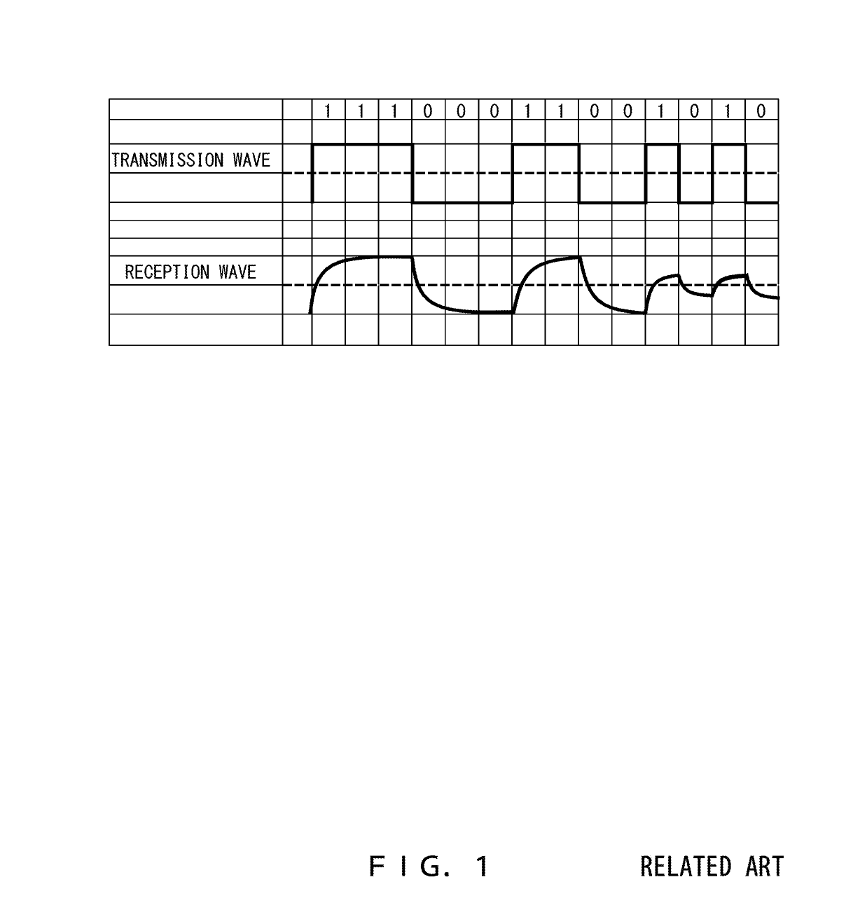

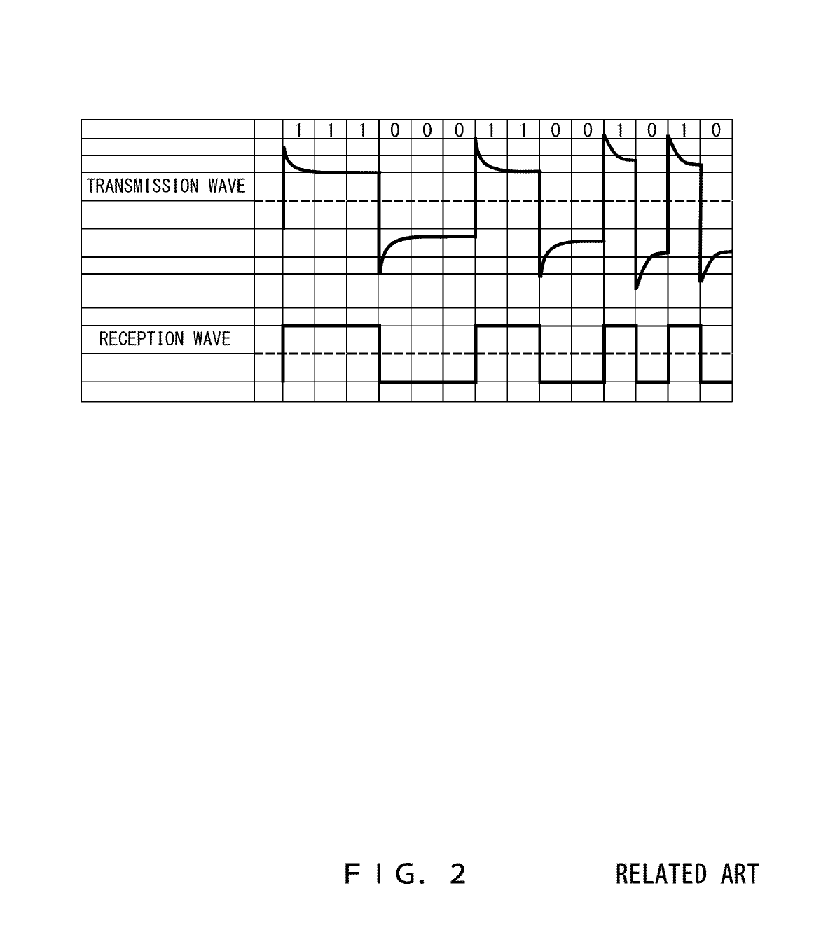

### DESCRIPTION OF EMBODIMENTS

Hereinafter, the embodiments will be described with reference to drawings.

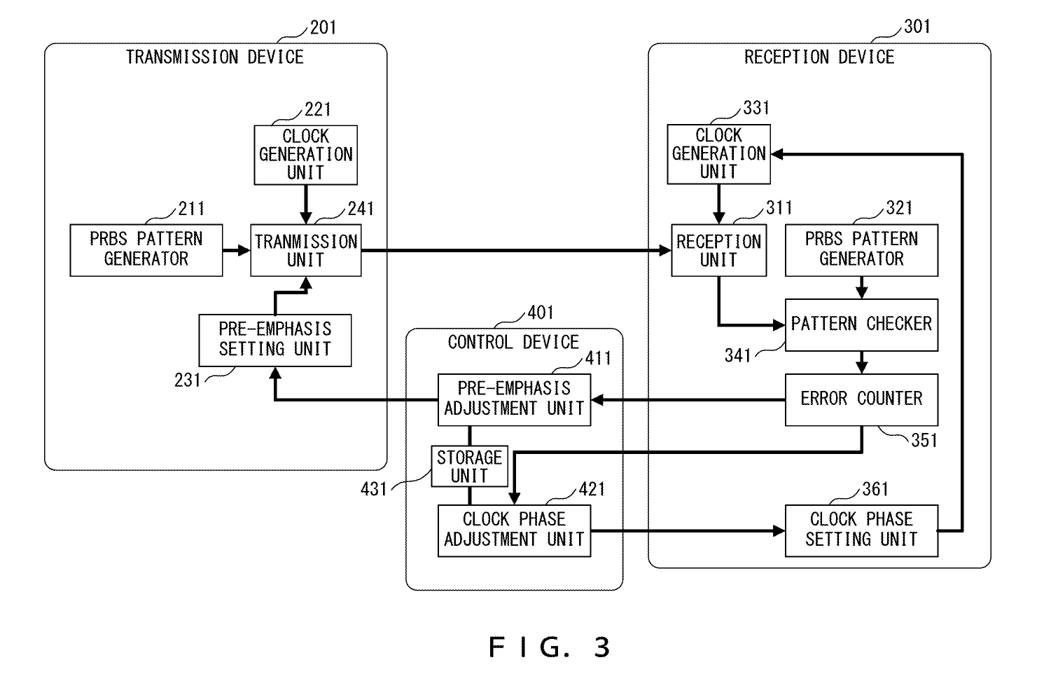

FIG. 3 is a configuration diagram of an information processing system according to the embodiments.

The information processing system 101 includes a transmission device 201, a reception device 301, and a control device 401.

The transmission device 201 is a device that transmits data to the reception device 301. The transmission device 201 is connected to the reception device 301 via a serial cable or a serial bus, and performs serial communication. The transmission device 201 is connected to the control device 401 via a network such as a Local Area Network (LAN).

The transmission device 201 includes a Pseudorandom Binary Sequence (PRBS) pattern generator 211, a clock generation unit 221, a pre-emphasis setting unit 231, and a transmission unit 241.

The PRBS pattern generator 211 generates a pseudorandom bit sequence (for example, 2²³−1 and 2³¹−1) as transmission data, and outputs it to the transmission unit 241.

The clock generation unit 221 generates a clock signal, and outputs it to the transmission unit 241.

The pre-emphasis setting unit 231 sets a set value that is specified by the control device 401 to the transmission unit 241.

The transmission unit 241 generates a signal that corresponds to input data, adjusts the signal on the basis of a pre-emphasis set value that is set by the pre-emphasis setting unit 231, and generates a transmission signal. The transmission unit 241 transmits the transmission signal to the reception device 301 in synchronization with the clock signal.

The reception device 301 includes a reception unit 311, a PRBS pattern generator 321, a clock generation unit 331, a pattern checker 341, an error counter 351, and a clock phase setting unit 361.

The reception unit 311 receives a signal that is transmitted from the transmission device 201 (hereinafter referred to as a reception signal), generates a bit (reception data) that corresponds to the reception signal in synchronization with a clock signal that is input from the clock generation unit 331, and outputs the reception data to the pattern checker 341.

The PRBS pattern generator 321 generates the same data as data that is generated by the PRBS pattern generator 211 of the transmission unit 201, and outputs the data to the pattern checker 341.

The clock generation unit 331 generates a clock signal according to a phase that is set by the clock phase setting unit 361, and outputs the clock signal to the reception unit 311.

The pattern checker 341 compares received data and data that is generated by the PRBS pattern generator 321 (that is, the data that is the same as transmission data), and checks whether they agree with each other or not.

The error counter 351 counts the number (the number of errors) of data items for which it has been determined that they disagree with each other (are errors) in the pattern checker 341. The error counter 351 transmits the number of errors to the pre-emphasis adjustment unit 411 and the clock phase adjustment unit 421. The error counter 351 transmits the number of patterns that are compared in the pattern checker 341 (that is, the number of bits of the transmission data) to the pre-emphasis adjustment unit 411 and the clock phase adjustment unit 421.

The clock phase setting unit 361 sets a phase in the clock generation unit 331 according to instructions from the control device 401.

The control device 401 is connected to the transmission device 201 and the reception device 301 via a network such as a Local Area Network (LAN).

The control device 401 includes a pre-emphasis adjustment unit 411, a clock phase adjustment unit 421, and a storage unit 431.

The pre-emphasis adjustment unit 411 instructs the pre-emphasis setting unit 231 to adjust a pre-emphasis parameter. In detail, the pre-emphasis adjustment unit 411 transmits a pre-emphasis set value to the pre-emphasis setting unit 231, and instructs the pre-emphasis setting unit to set a pre-emphasis parameter to the set value.

The clock phase adjustment unit 421 instructs the clock phase setting unit 361 to adjust a clock phase.

For example, the pre-emphasis adjustment unit 411 and the clock phase adjustment unit 421 are realized by loading a program from a memory and executing it by a CPU. In addition, the pre-emphasis adjustment unit 411 and the clock phase adjustment unit 421 may be realized by a hardware circuit such as a Digital Signal Processor (DSP) and an Application Specific Integrated Circuit (ASIC).

The storage unit 431 stores data that is used in the pre-emphasis adjustment unit 411 and the clock phase adjustment unit 421. An example of the storage unit 431 is a Random Access memory (RAM).

Next, a method for calculating an eye diagram (eye pattern) width (eye width) and an optimum value of a clock phase will be described.

First, an eye diagram width (eye width) and a clock phase that are used in the embodiments will be described.

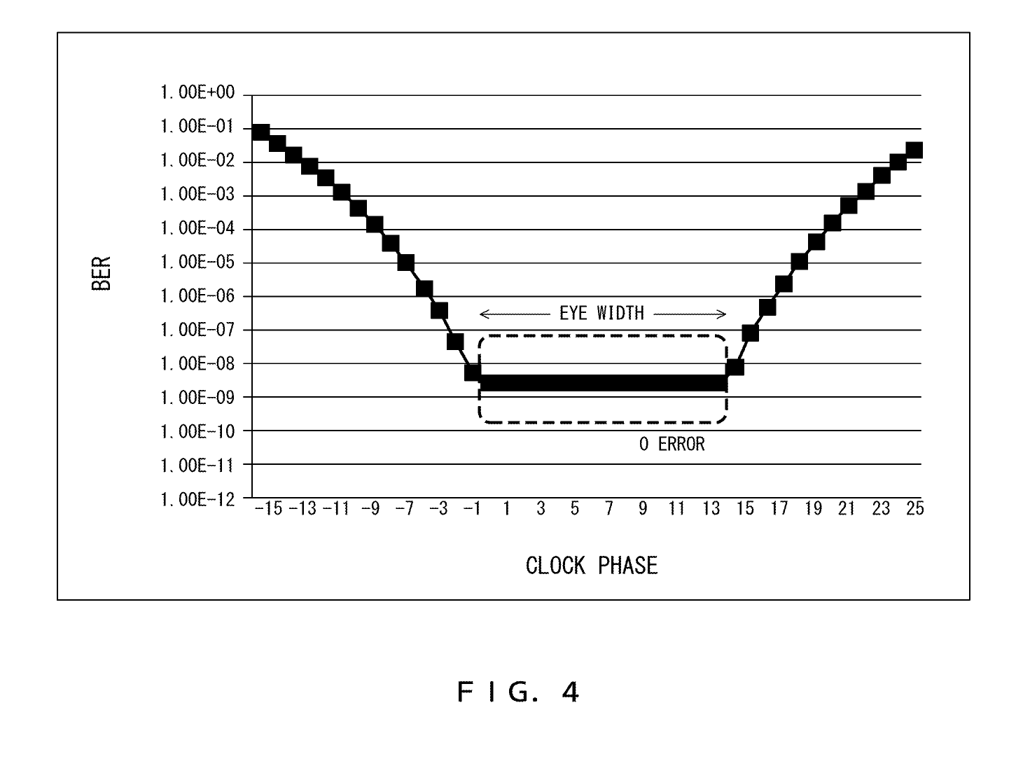

FIG. 4 is a diagram illustrating a bathtub curve.

The bathtub curve illustrated in FIG. 4 can be obtained by measuring a Bit Error Rate (BER) to a clock phase.

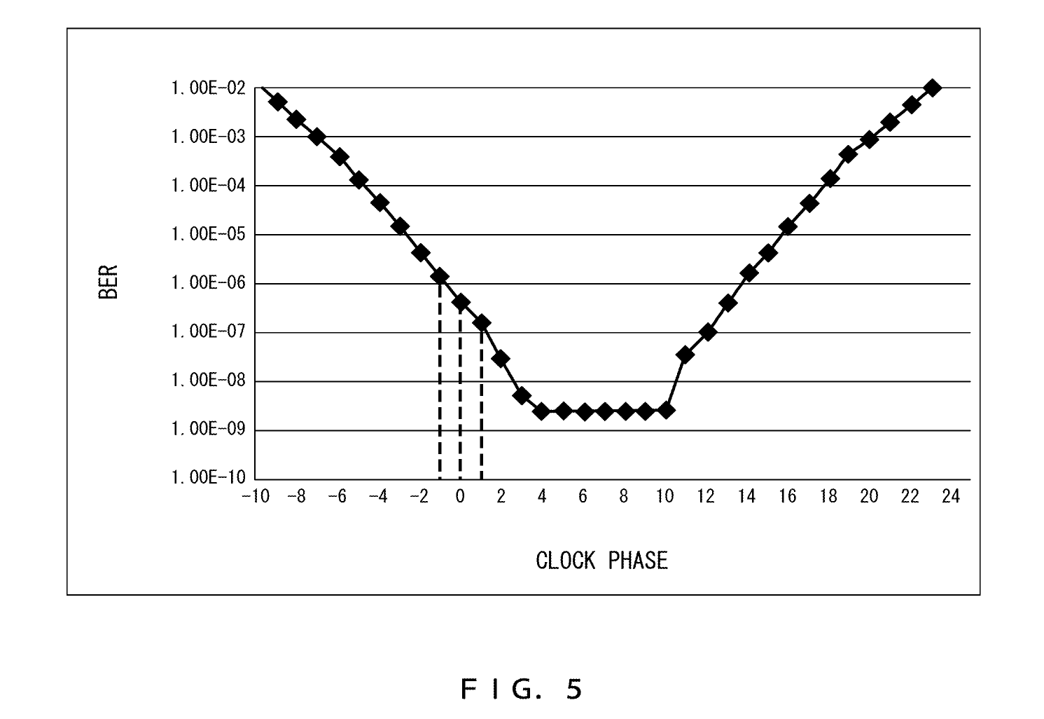

The vertical axis in FIG. 4 indicates a BER and the horizontal axis in FIG. 4 indicates a clock phase. Descriptions of the vertical axis and the horizontal axis are the same as those in FIG. 5-14 that will be described hereinafter.

A BER indicates an error ratio of data that is received by the reception device 301. The BER is a value that is obtained by dividing the number of errors by the number of pieces of received data (patterns). In the embodiments, when the number of errors is 0 (0 errors), BER=0 is satisfied for the purpose of calculation; however, for the purpose of display, the BER is calculated assuming for convenience that the number of errors=1, instead of setting BER=0. Alternatively, a sufficiently small appropriate value is displayed as the BER.

As a result, although it seems that errors are detected even in a range of 0-13 clock phases in the bathtub curve in FIG. 4, the number of errors is 0 in actual measurement.

In FIG. 4, a BER in a case in which there are 0 errors, that is, a BER that corresponds to 0-13 clock phases, is plotted as a constant between 1.00E-9 and 1.00E-8.

A clock phase is a phase of a clock signal that is generated by the clock generation unit 331 of the reception device 301. In the embodiments, a unit of a clock phase is a time obtained by dividing a unit interval (UI) by 32. The UI is a time that corresponds to a period of a bit of a data signal. For example, adding 1 to a clock phase means adding a time that corresponds to 1/32*UI to the value of the present clock phase.

The number of clock phases when there are 0 errors in a bathtub curve is an eye diagram width (eye width). There are a plurality of phases in which there are 0 errors, because a measurement time is limited.

In FIG. 4, there are 0 errors in the range of 0-13 clock phases. As a result, an eye width is 13(=13-0).

In the embodiments, whether or not a pre-emphasis set value is optimum is determined by using an eye width. Since it can be said that the wider an eye width is, the greater a transfer margin there is, a set value with the largest eye width is determined in the embodiments.

Next, a clock phase adjustment process, and in detail a method for calculating an eye width and an optimum value of a clock phase, will be described.

In the embodiments, an eye width can be calculated by minimum measurement by using local search with an optional center value of a parameter as a start point.

Hereinafter, a case of adjusting a clock phase of a first-order parameter will be described. It is assumed that an appropriate value is set as a pre-emphasis set value.

FIG. 5 is a diagram illustrating a bathtub curve.

In FIGS. 5-14, in order to facilitate understanding, a bathtub curve is drawn by plotting BERs for all clock phases that can be displayed. However, BERs for clock phases in which error measurement is not performed is not actually calculated by the control device 401.

At first, an optional value is set as a center value. Then, peripheral values that are next to the center value are set, and the number of errors at three points, the center value and the peripheral values, is measured.

Hereinafter, three cases will be described.

1. First Case

When a center value is set to be 0, the peripheral values next to it are −1 and +1. The number of errors when the clock phase of the reception unit 301 is set to be the three values of −1, 0 and 1 is measured, respectively (FIG. 5).

When the number of errors when the set value is +1 is smaller than that when the set value is −1, then +1, which has the smaller number of errors, is set as a new center value.

Peripheral values of the new center value are 0 and +2, and only the number of errors of the peripheral value+2 is newly measured, since the number of errors when the peripheral value is 0 has already been measured.

Thereafter, the above process is repeated until the number of errors becomes 0.

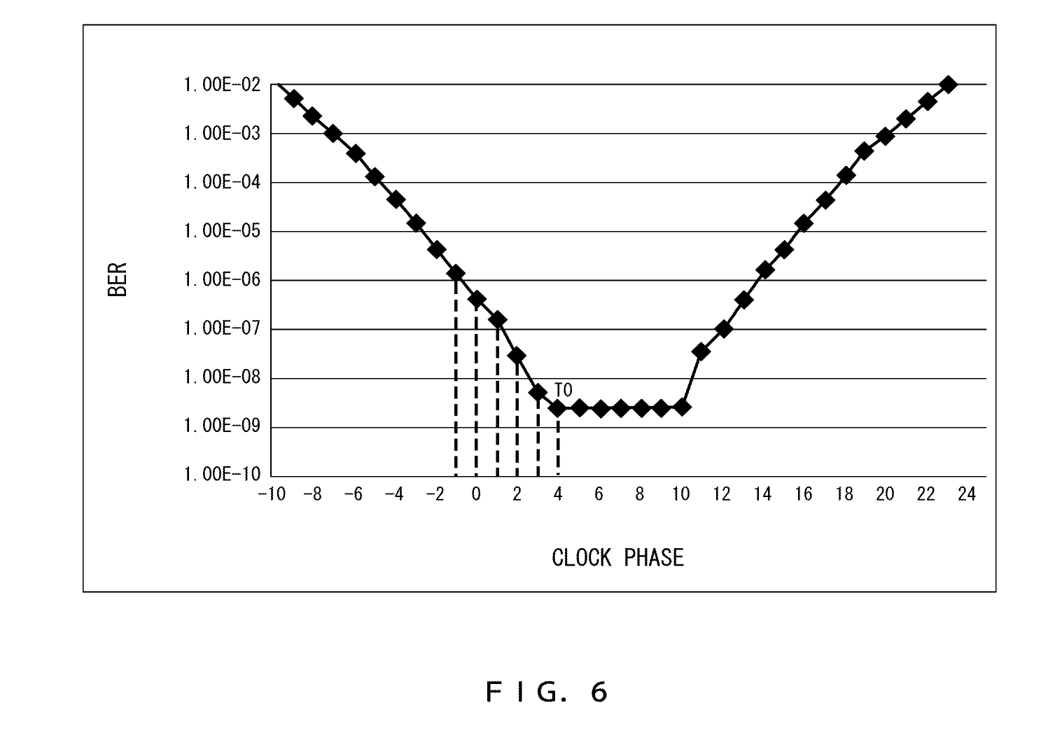

FIG. 6 is a diagram illustrating the left end of the eye diagram width in the bathtub curve.

A set value when the number of errors is 0 is the left end T0 of the eye diagram width (eye width) (FIG. 6).

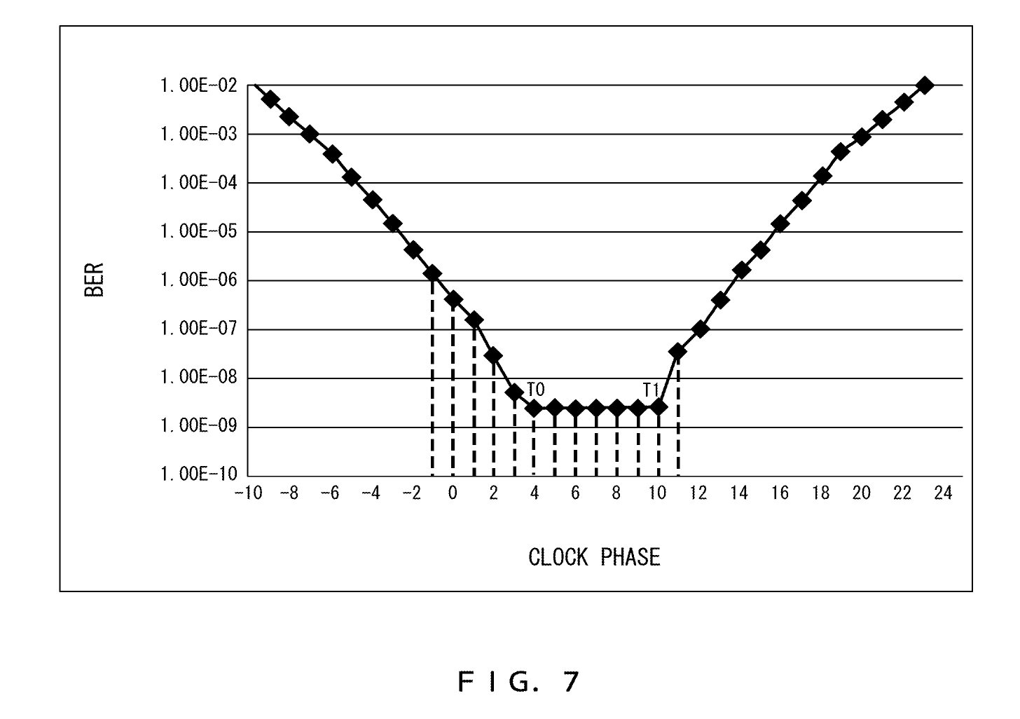

FIG. 7 is a diagram illustrating the right end of the eye width in the bathtub curve.

The clock phase set value is increased continuously, measurement of the number of errors of the set value is repeated until an error occurs, and a set value at which the number of errors finally becomes 0 is set as the right end T1 of the eye diagram width (FIG. 7).

In addition, the optimum value of the clock phase can be determined by (T2−T1)/2.

2. Second Case

Next, a case will be described wherein the number of errors of three respective points, a center value and peripheral values, is measured, and the number of errors when a set value is (the center value+1) is larger than the number of errors when a set value is (the center value−1).

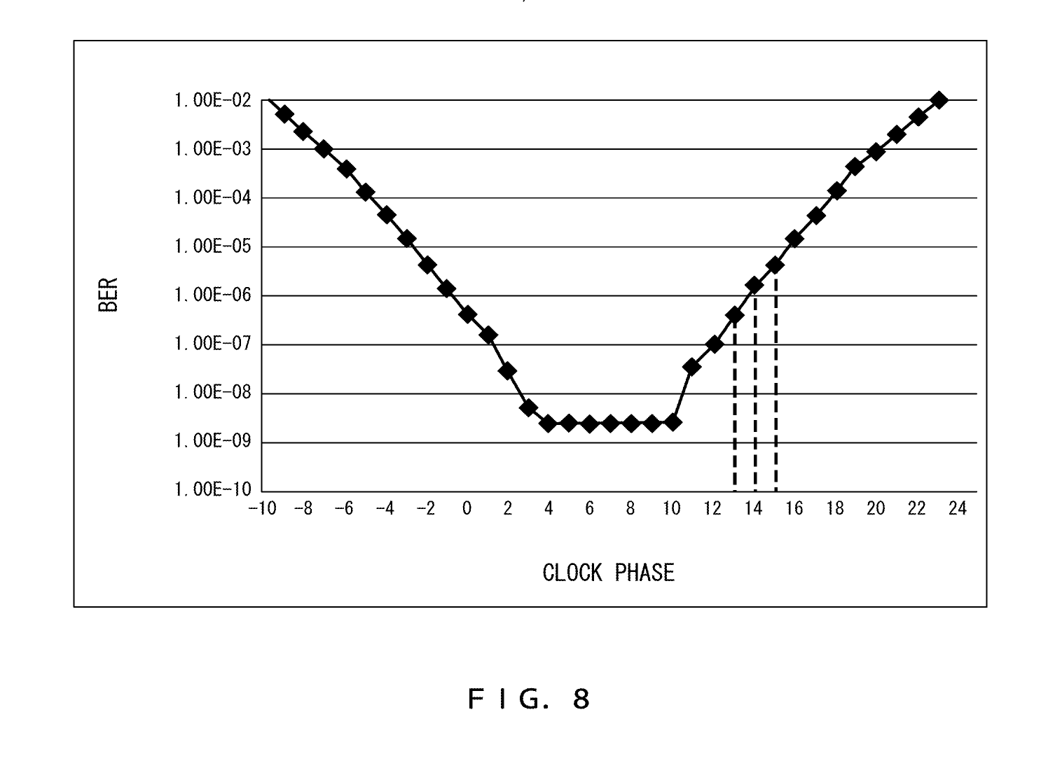

FIG. 8 is a diagram illustrating a bathtub curve.

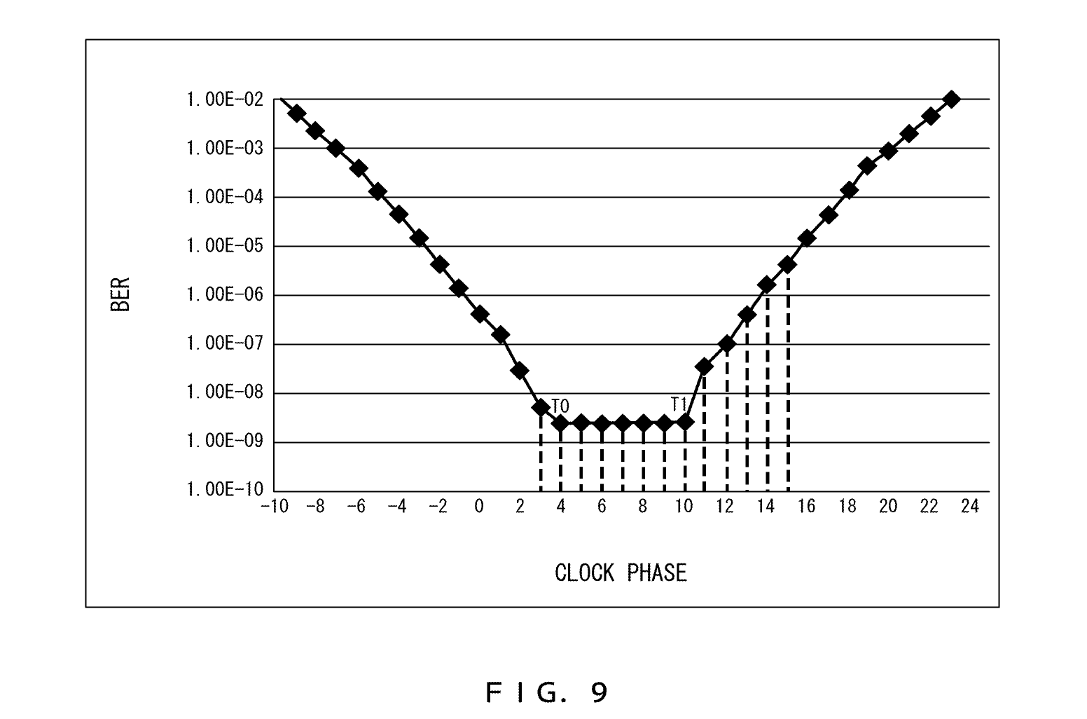

FIG. 9 is a diagram illustrating the right end and the left end of the eye width in the bathtub curve.

In FIG. 8, when a center value is set to be 14, neighboring peripheral values are 13 and 15.

When the number of errors when the set value is 15 is larger than the number of errors when the set value is 13 (FIG. 8), a set value that has fewer errors is set as a new center value in the same manner as in the above process, measurement is repeated, and the set value that has 0 errors is set as the right end T1 of the eye diagram width. The clock phase set value is continuously decreased, measurement of the number of errors of the set value is repeated until an error occurs, and the set value at which the number of errors finally becomes 0 is set as the left end T0 of the eye diagram width (FIG. 9).

3. Third Case

A case will be described wherein the number of errors of three respective points, a center value and peripheral values, are measured and the numbers of errors of the three points are all 0.

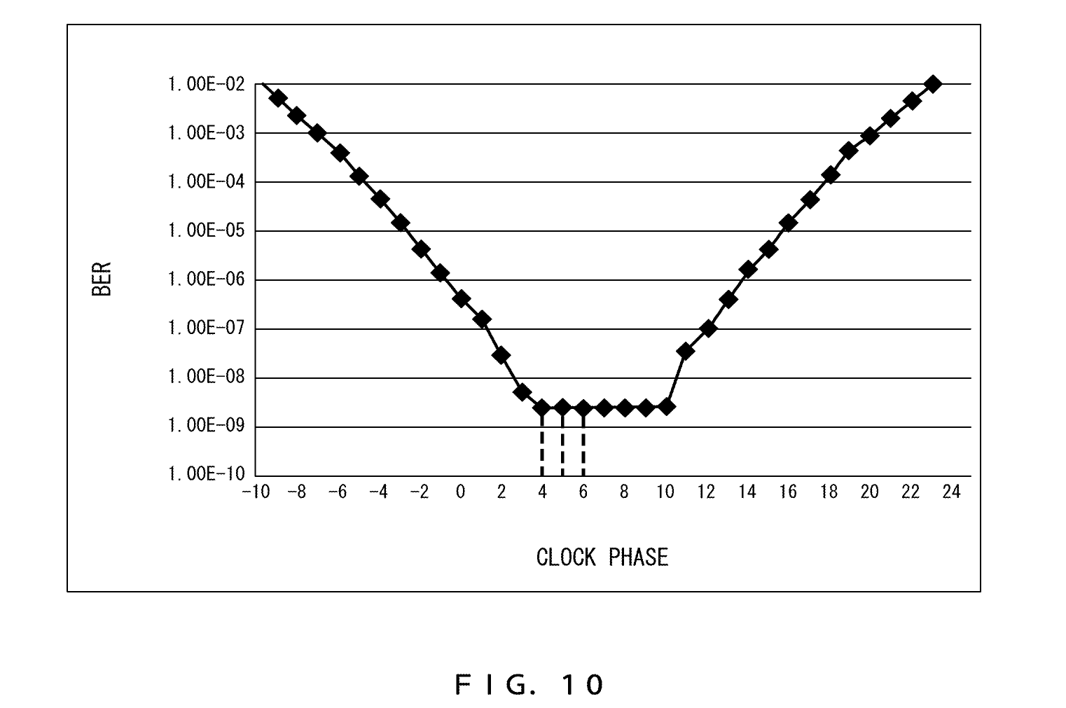

FIG. 10 is a diagram illustrating a bathtub curve.

When the center value is set to be 5, neighboring peripheral values are 4 and 6.

When the numbers of errors of the three points are all 0 (FIG. 10), the center value remains the same and the peripheral values are extended by ±1.

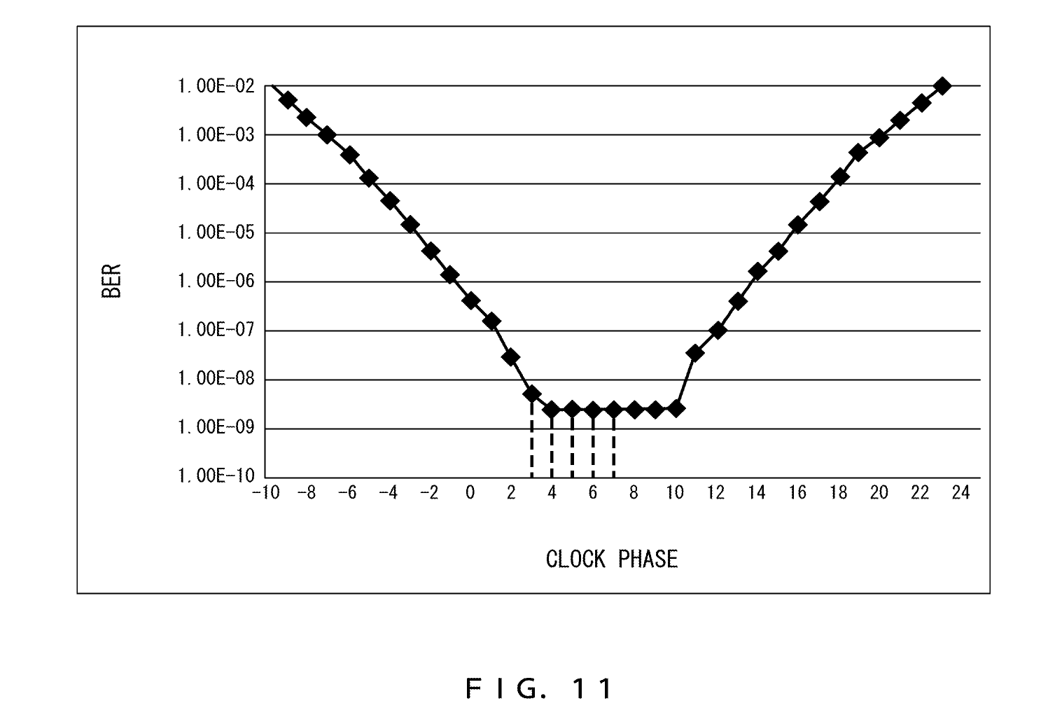

FIG. 11 is a diagram illustrating extension of peripheral values.

When a center value is 5 and peripheral values are extended, four points, 3, 4, 5 and 6, become peripheral values (FIG. 11).

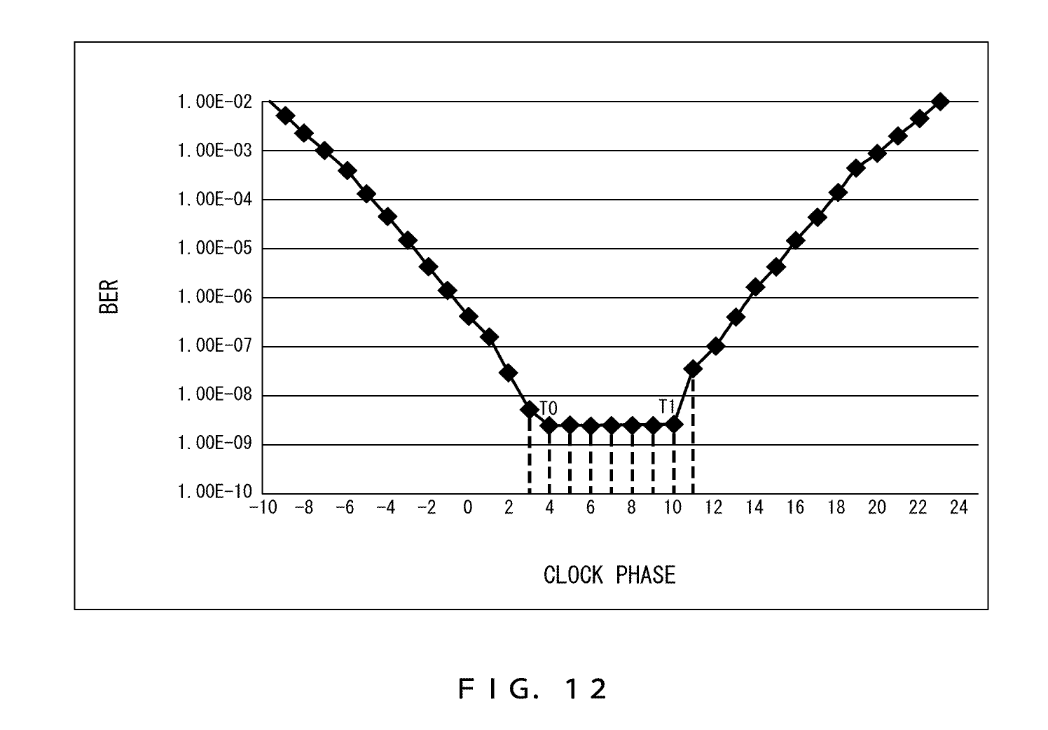

FIG. 12 is a diagram illustrating the right end and the left end of the eye width in the bathtub curve.

Peripheral values are newly set by extending peripheral values in both plus and minus directions, and the number of errors of each new peripheral value is measured. This process is repeated until an error is measured. With respect to a peripheral value which is extended in the minus direction, when an error occurs at the set value 3, the set value 4 at which the number of errors finally becomes 0 becomes the left end T0 of the eye diagram width. Next, with respect to a peripheral value that is extended in the plus direction, the number of errors is measured by extending the peripheral value by +1 in order to determine the right end T1 of the eye diagram width, and a process for increasing the peripheral value until an error occurs is repeated (FIG. 12). When an error occurs at the set value 11, the set value 10 at which the number of errors finally becomes 0 becomes the right end T1 of the eye diagram width. At this time, measurement of a set value which is smaller than the set value T0 of the left end and at which an error has already occurred is omitted.

Here, adjustment of an initial value (a start phase setting process) in second and subsequent error measurement (that is, when the pre-emphasis set value is changed) will be described.

In second and subsequent clock phase adjustment processes in which the same data is used, when pre-emphasis is intensified (when the pre-emphasis set value is increased) in comparison with the previous clock phase adjustment process, the clock phase in which there are 0 errors is shifted in the minus direction. Therefore, a point which is shifted in the minus direction with reference to the previous measurement data (T1, T2) is set as a start point (initial value) (Ts0, Ts1). Ts0 is an initial value of a clock phase that is used for determining the left end of the eye diagram width, and Ts1 is an initial value of a clock phase that is used for determining the right end of the eye diagram width.

When pre-emphasis is weakened (when the pre-emphasis set value is decreased), a clock phase in which there are no errors is shifted in the plus direction. Therefore, a point that is shifted in the plus direction with reference to the previous measurement data (T1, T2) is set as a start point (initial value) (Ts0, Ts1).

When one pre-emphasis parameter is intensified, a start point is shifted by −1, and when the parameter is weakened, the start point is shifted by +1. Therefore, when two parameters are intensified, the start point is shifted by −2. When one parameter from among the two parameters is intensified and the other parameter is weakened, the start point is not shifted. When both of the two parameters are weakened, the start point is shifted by +2.

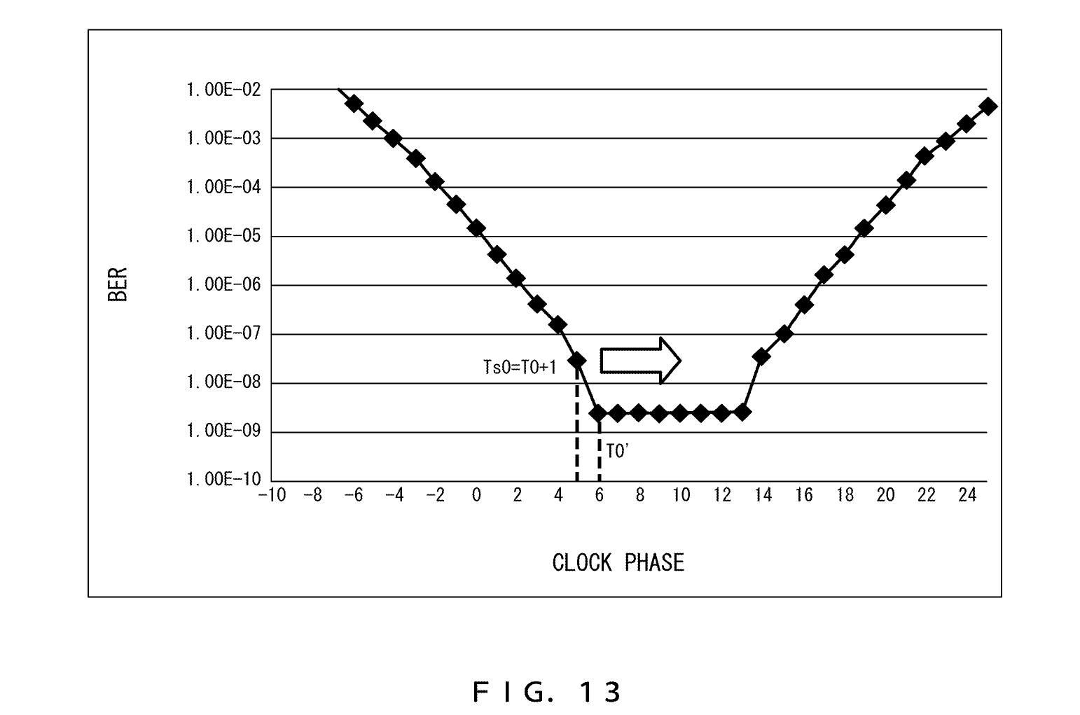

FIG. 13 is a diagram illustrating an initial value of the left side of error measurement in second and subsequent clock phase adjustment processes.

FIG. 13 illustrates a case in which only one parameter is weakened from the previous pre-emphasis set value. Therefore, the initial value (start phase) Ts0 of a clock phase in which error measurement is performed for calculation of the left end T0′ of the eye diagram width is a value that is obtained by adding 1 to the left end T0 of the eye diagram width.

As a result, the number of errors in the clock phase=T0+1 is measured at first, the clock phase is increased by +1 when the number of errors is not 0 (when there are errors), and the number of errors in the increased clock phase is measured. Increasing of the clock phase and measurement of the number of errors are repeated until the number of errors becomes 0, and the left end T0′ of the eye diagram width is calculated.

When the number of errors is 0 in the clock phase Ts0, the clock phase is decreased by 1, the number of errors in the decreased clock phase is measured, decreasing of the clock phase and measurement of the number of errors are repeated until an error occurs, and the left end T0′ of the eye diagram width is calculated.

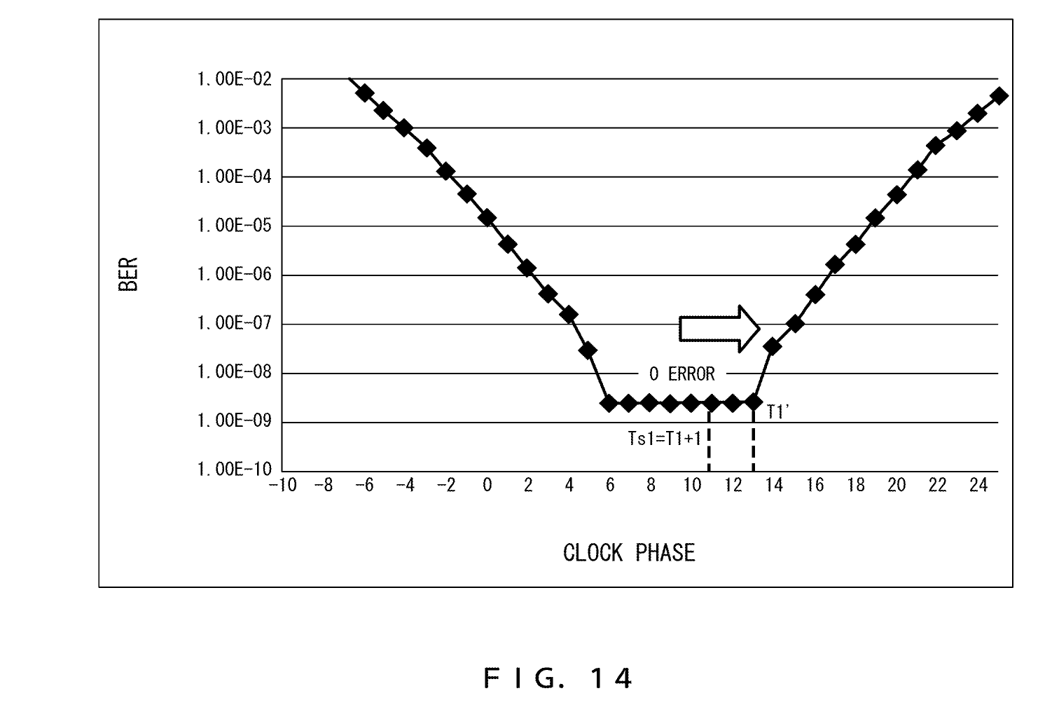

FIG. 14 is a diagram illustrating an initial value at the right side of error measurement in second and subsequent clock phase adjustment processes.

When T0′ is calculated, the right end T1′ of the eye diagram width is determined in the same manner. The initial value (start phase) Ts1 of the clock phase in which error measurement is performed for calculation of the right end T1′ of the eye diagram width is a value that is obtained by adding 1 to the right end T1 of the eye diagram width, which is calculated in the previous process.

As a result, the number of errors in the clock phase=T1+1 is measured at first, the clock phased is increased by 1 when the number of errors is 0, and the number of errors in the increased clock phase is measured. Increasing of the clock phase and measurement of the number of errors are repeated until an error occurs, and the right end T1′ of the eye diagram width is calculated.

In the clock phase Ts1, when there is an error, the clock phase is decreased by 1, and the number of errors of the decreased phase is measured. Decreasing of the clock phase and measurement of the number of errors are repeated until the number of errors becomes 0, and the right end T1′ of the eye diagram width is calculated.

As described above, since an initial value of a clock phase that is used in error measurement is adjusted on the basis of the right end and the left end of the eye width that are measured in the previous process and the change in the pre-emphasis set value, unnecessary calculations are avoided, and an eye width can be determined quickly.

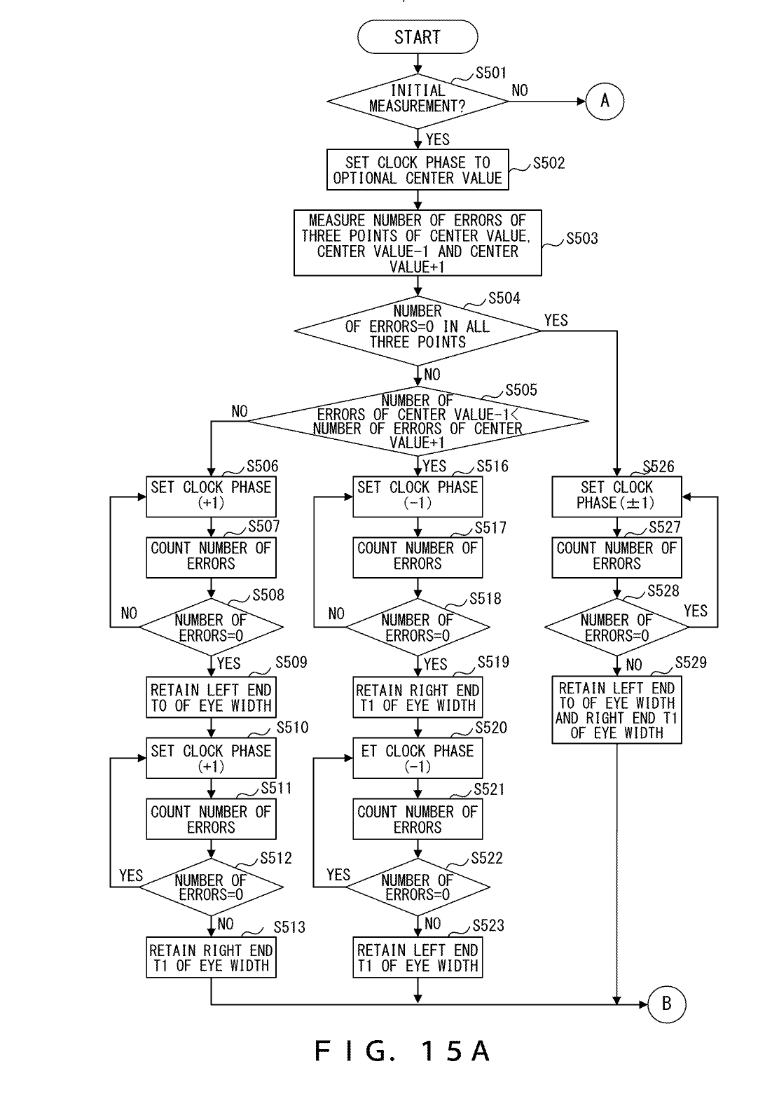

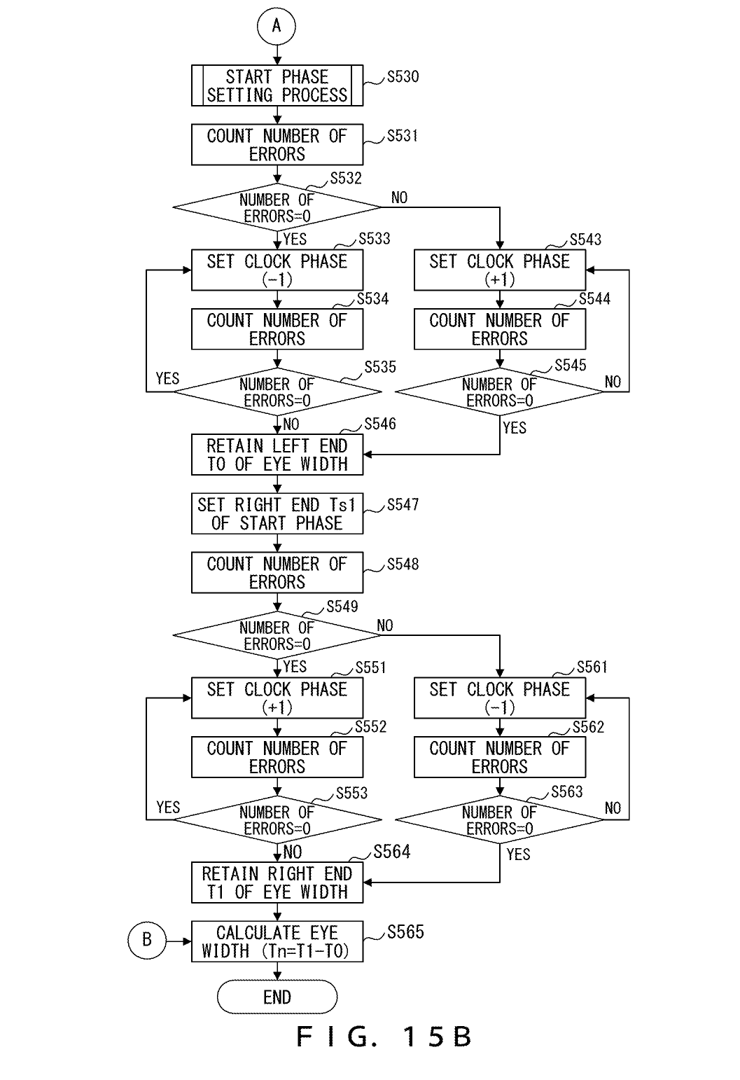

FIGS. 15A and 15B are a flowchart of a clock phase adjustment process.

In step S501, the clock phase adjustment unit 421 determines whether or not this measurement is the first measurement. When this measurement is the first measurement, a control proceeds to step S502, and when this measurement is not the first measurement, the control proceeds to step S530.

In step S502, the clock phase adjustment unit 421 sets the clock phase to an optional center value. The clock phase adjustment unit 421 outputs to the clock phase setting unit 361 an instruction to set the clock phase to the center value. The clock phase setting unit 361 sets the center value to the clock generation unit 331.

After the clock phase is adjusted, data is transmitted from the transmission device 201 to the reception device 301.

In step S503, the error counter 351 counts the number of errors, and transmits the counted number of errors and the number of patterns to the clock phase adjustment unit 421 and the pre-emphasis adjustment unit 411. The clock phase adjustment unit 421 stores the clock phase (=the center value), the number of errors, and the number of patterns in the storage unit 431 in association with each other.

Next, the clock phase adjustment unit 421 sets the clock phase to the center value−1. The clock phase adjustment unit 421 outputs to the clock phase setting unit 361 an instruction to set the clock phase to the center value−1. The clock phase setting unit 361 sets the clock phase on the basis of the instruction. Data is sent from the transmission device 201 to the reception device 301, the error counter 351 counts the number of errors when the clock phase=the center value−1, and the clock phase adjustment unit 421 stores the clock phase (=the center value−1), the number of errors, and the number of patterns in the storage unit 431 in association with each other.

Then, the clock phase adjustment unit 421 sets the clock phase to the center value+1. The clock phase adjustment unit 421 outputs to the clock phase setting unit 361 an instruction to set the clock phase to the center value+1, and the clock phase setting unit 361 sets the clock phase on the basis of the instruction. Data is transmitted from the transmission device 201 to the reception device 301, the error counter 351 counts the number of errors when the clock phase=the center value+1, and the clock phase adjustment unit 421 stores the clock phase (=the center value+1), the number of errors, and the number of patterns in the storage unit 431 in association with each other.

By the above process, the number of errors when the clock phase is the center value, when the clock phase is the center value−1, and when the clock phase is the center value+1 is measured, respectively.

In step S504, the clock phase adjustment unit 421 checks the number of errors in a case in which the clock phase is the center value, a case in which the clock phase is the center value−1, and a case in which the clock phase is the center value+1, respectively, and a control proceeds to step S526 when the number of errors is 0 in all the cases, and the control proceeds to step S505 unless the number of errors is 0 in all the cases.

In step S505, the clock phase adjustment unit 421 compares the number of errors when the clock phase=the center value−1 and the number of errors when the clock phase=the center value+1. When the number of errors when the clock phase=the center value+1 is larger than the number of errors when the clock phase=the center value−1, a control proceeds to step S516, and when the number of errors when the clock phase=the center value+1 is not larger than the number of errors when the clock phase=the center value−1, the control proceeds to step S506.

In S506, the clock phase adjustment unit 421 adds 1 to the present clock phase, and sets a new clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S507, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S508, the clock phase adjustment unit 421 checks the number of errors. When the number of errors is 0, a control proceeds to step S509, and when the number of errors is not 0, the control returns to step S506. The clock phase when the number of errors is 0 is set as the left end T0 of the eye width.

In step S509, the clock phase adjustment unit 421 stores the left end T0 of the eye width in the storage unit 431.

In step S510, the clock phase adjustment unit 421 adds 1 to the present clock phase, and sets a new clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S511, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S512, the clock phase adjustment unit 421 checks the number of errors. When the number of errors is 0, a control returns to step S510, and when the number of errors is not 0, the control proceeds to step S513. The value that is obtained by subtracting 1 from the clock phase when the number of errors is not 0 (that is, the clock phase when the number of errors is finally determined to be 0) is set as the right end T1 of the eye width.

In step S513, the clock phase adjustment unit 421 stores the right end T1 of the eye width in the storage unit 431.

In step S516, the clock phase adjustment unit 421 subtracts 1 from the present clock phase, and sets a new clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S517, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S518, the clock phase adjustment unit 421 checks the number of errors. When the number of errors is 0, a control proceeds to step S519, and when the number of errors is not 0, the control returns to step S516. The clock phase when the number of errors is 0 is set as the right end T1 of the eye width.

In step S519, the clock phase adjustment unit 421 stores the right end T1 of the eye width in the storage unit 431.

In step S520, the clock phase adjustment unit 421 subtracts 1 from the present clock phase, and sets a new clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S521, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S522, the clock phase adjustment unit 421 checks the number of errors. When the number of errors is 0, a control returns to step S520, and when the number of errors is not 0, the control proceeds to step S523. The value that is obtained by adding 1 to the clock phase when the number of errors is not 0 (that is, the clock phase when the number of errors is finally determined to be 0) is set as the left end T0 of the eye width.

In step S523, the clock phase adjustment unit 421 stores the left end T0 of the eye width in the storage unit 431.

In step S526, when the left end T0 of the eye width has not yet been calculated, the clock phase adjustment unit 421 subtracts 1 from the present clock phase, which is smaller than the center value, and sets a new left side clock phase. When the right end T1 of the eye width has not yet been calculated, the clock phase adjustment unit 421 adds 1 to the present clock phase, which is larger than the center value, and sets a new right side clock phase. The clock phase adjustment unit 421 outputs to the clock phase setting unit 361 an instruction to adjust the left side clock phase and the right side clock phase to the new left side clock phase and the new right side clock phase.

After the clock phase is adjusted, data is transmitted from the transmission device 201 to the reception device 301 in the same manner as in the above process.

In step S527, the error counter 351 counts the number of errors in the left side clock phase and the right side clock phase, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S528, the clock phase adjustment unit 421 checks the number of left side clock phase errors and the number of right side clock phase errors. When at least one of the numbers of errors is 0, a control proceeds to step S526, and if neither of the numbers of errors is 0, the control proceeds to step S529. The value that is obtained by adding 1 to the left side clock value when the number of left side clock phase errors is not 0 is set as the left end T0 of the eye width. The value that is obtained by subtracting 1 from the right side clock phase when the number of right side clock phase errors is not 0 is set as the right end T1 of the eye width.

In step S529, the clock phase adjustment unit 421 stores the left end T0 of the eye width and the right end T1 of the eye width in the storage unit 431.

In step S530, the clock phase adjustment unit 421 performs the start phase setting process described hereinbefore. The start phase left end Ts0 and the start phase right end Ts1 are calculated by the start phase setting process. The clock phase adjustment unit 421 sets the start phase left end Ts0 as a new clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S531, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S532, the clock phase adjustment unit 421 checks the number of errors. When the number of errors is 0, a control proceeds to step S533, and when the number of errors is not 0, the control proceeds to step S543.

In step S533, the clock phase adjustment unit 421 sets a new clock phase by subtracting 1 from the present clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S534, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S535, the clock phase adjustment unit 421 checks the number of errors. When the number of errors is 0, a control returns to step S533, and when the number of errors is not 0, the control proceeds to step S546. The value that is obtained by adding 1 to the clock phase when the number of errors is not 0 (that is, the clock phase when it is finally determined that the number of errors is 0) is set as the left end T0 of the eye width.

In step S543, the clock phase adjustment unit 421 adds 1 to the present phase, and sets a new clock phase. The clock phase adjustment unit 421 outputs to the clock phase setting unit 361 an instruction to adjust the phase to the new clock phase.

After the clock phase is adjusted, data is transmitted from the transmission device 201 to the reception device 301 in the same manner as in the above process.

In step S544, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S545, the clock phase adjustment unit 421 checks the number of errors. When the number of errors is 0, a control proceeds to step S546, and when the number of errors is not 0, the control returns to step S543. The clock phase when the number of errors is 0 is set as the left end T0 of the eye width.

In step S546, the clock phase adjustment unit 421 stores the left end T0 of the eye width in the storage unit 431.

In step S547, the clock phase adjustment unit 421 sets the start phase right end Ts1 that is calculated in step S530 as a new clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S548, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S549, the clock phase adjustment unit 421 checks the number of errors. When the number of errors is 0, a control proceeds to step S551, and when the number of errors is not 0, the control proceeds to step S561.

In step S551, the clock phase adjustment unit 421 sets a new clock phase by adding 1 to the present clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S552, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S553, the clock phase adjustment unit 421 checks the number of errors. When the number of errors is 0, a control returns to step S551, and when the number of errors is not 0, the control proceeds to step S564. The value that is obtained by subtracting 1 from the clock phase when the number of errors is not 0 (that is, the clock phase when it has finally been determined that the number of errors is 0) is set as the right end T1 of the eye width.

In step 561, the clock phase adjustment unit 421 subtracts 1 from the present clock phase, and sets a new clock phase. The clock phase adjustment unit 421 outputs to the clock phase setting unit 361 an instruction to adjust the clock phase to the new clock phase.

After the clock phase is adjusted, data is transmitted from the transmission device 201 to the reception device 301 in the same manner as in the above process.

In step S562, the error counter 351 counts the number of errors, and transmits the counted number of errors and the number of patterns to the clock phase adjustment unit 421 and the pre-emphasis adjustment unit 411. The clock phase adjustment unit 421 stores the clock phase, the number of errors, and the number of patterns in the storage unit 431 in association with each other.

In step S563, the clock phase adjustment unit 421 checks the number of errors. When the number of errors is 0, a control proceeds to step S564, and when the number of errors is not 0, the control returns to step S561. The clock phase when the number of errors is 0 is set as the right end T1 of the eye width.

In step S564, the clock phase adjustment unit 421 stores the right end T1 of the eye width in the storage unit 431.

In step S565, the clock phase adjustment unit 421 subtracts the left end T0 of the eye width from the right end T1 of the eye width, and calculates the eye width Tn(=T1−T0).

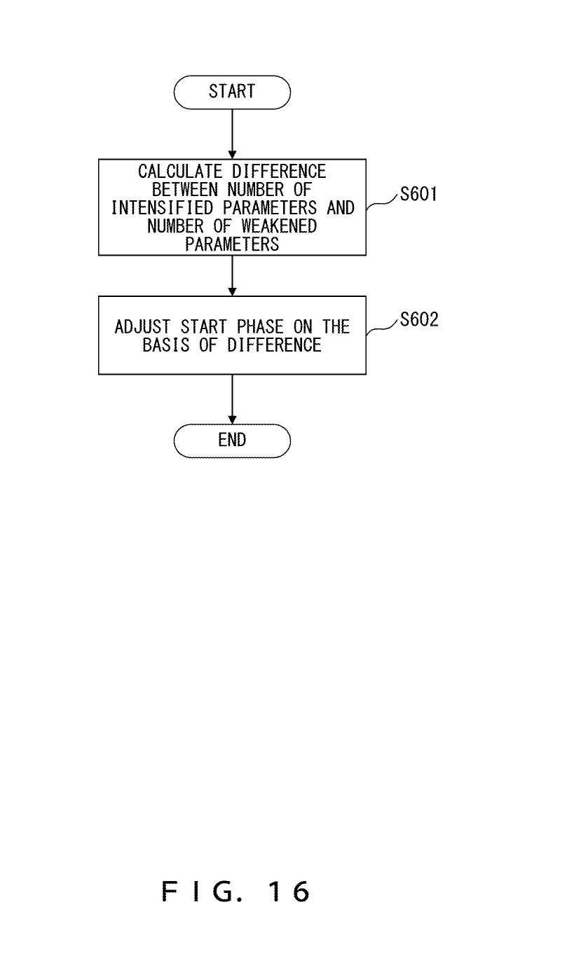

FIG. 16 is a flowchart of a start position setting process.

FIG. 16 corresponds to step S530 in FIG. 15.

In step S601, the clock phase adjustment unit 421 compares the pre-emphasis set value that is set in the previous process and the pre-emphasis set value that is set in the present process, and calculates the difference between the number of pre-emphasis set values that increase and the number of pre-emphasis set values that decrease.

In step S602, the clock phase adjustment unit 421 adjusts the start phase on the basis of the calculated difference. In detail, the left end Ts0 of the start phase is calculated by subtracting the difference from the left end T0 of the eye width, and the right end Ts1 of the start phase is calculated by subtracting the difference from the right end T1 of the eye width. The left end T0 of the eye width and the right end T1 of the eye width are values that are calculated in the previous clock phase adjustment process.

Next, a pre-emphasis adjustment process for optimizing pre-emphasis parameters will be described. In the embodiments, local search is used for calculating the optimum pre-emphasis parameters.

Here, a case will be described wherein there are two pre-emphasis parameters.

In the case of second-order parameters, at first, a center value of the pre-emphasis parameters are set optionally, and the eye diagram width (eye width) that is another parameter is measured. The method of measuring the eye width is the same as described above.

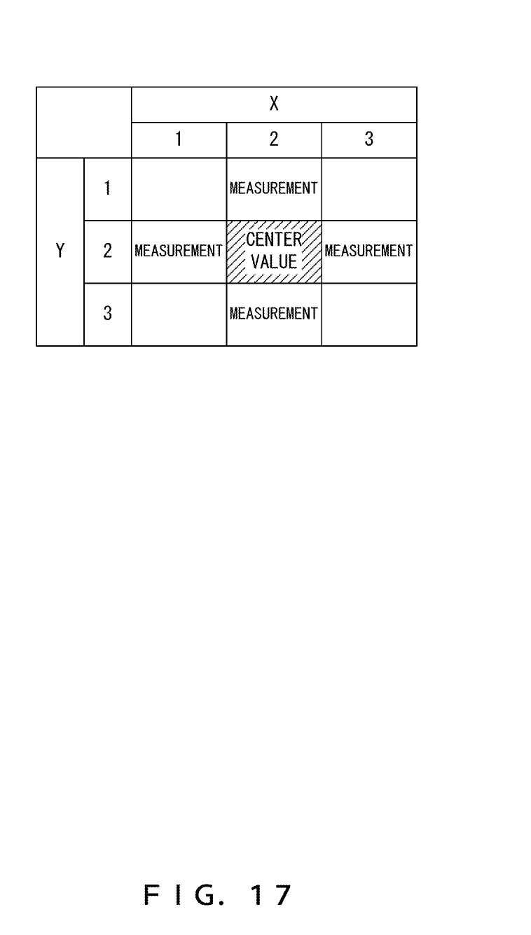

FIG. 17 is a diagram illustrating measurement points.

The center value of two pre-emphasis parameters (X,Y) is set as (X,Y)=(2,2).

Then, peripheral values with respect to the center value are set. The peripheral values are obtained by shifting each parameter by +1 or −1 from the center value.

In the case of the second-order parameters, the peripheral values are the following four points: (X,Y)=(center value+1, center value), (center value−1, center value), (center value, center value+1), and (center value, center value−1). Then, the eye width of each of them is measured while setting the center value and the peripheral values as measurement points (FIG. 17).

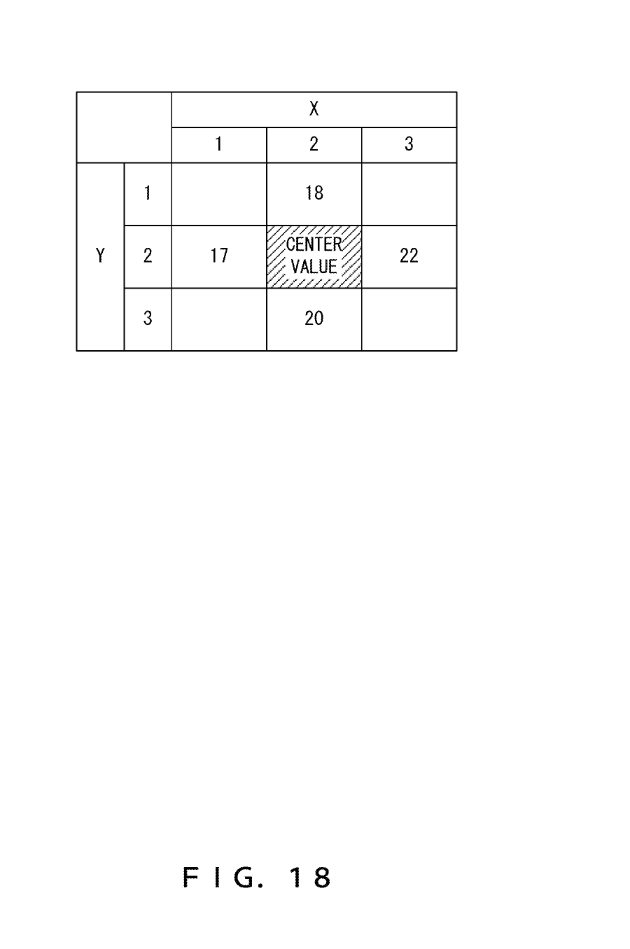

FIG. 18 is a diagram illustrating measurement results.

As illustrated in FIG. 18, it is assumed that the measurement results (eye widths) of the peripheral values (center value+1, center value), (center value−1, center value), (center value, center value+1), and (center value, center value−1) are 22, 17, 20, and 18, respectively.

Then, the measurement results of the peripheral values (center value+1, center value) and (center value−1, center value), and the measurement results of (center value, center value+1) and (center value, center value−1) are compared with each other, respectively, and a better peripheral value (a peripheral value with a larger eye diagram width) is determined to be ∘ (large), and a worse peripheral value (a peripheral value with a smaller eye diagram width) is determined to be x (small). When the measurement results are the same value, both peripheral values are determined to be Δ (equal).

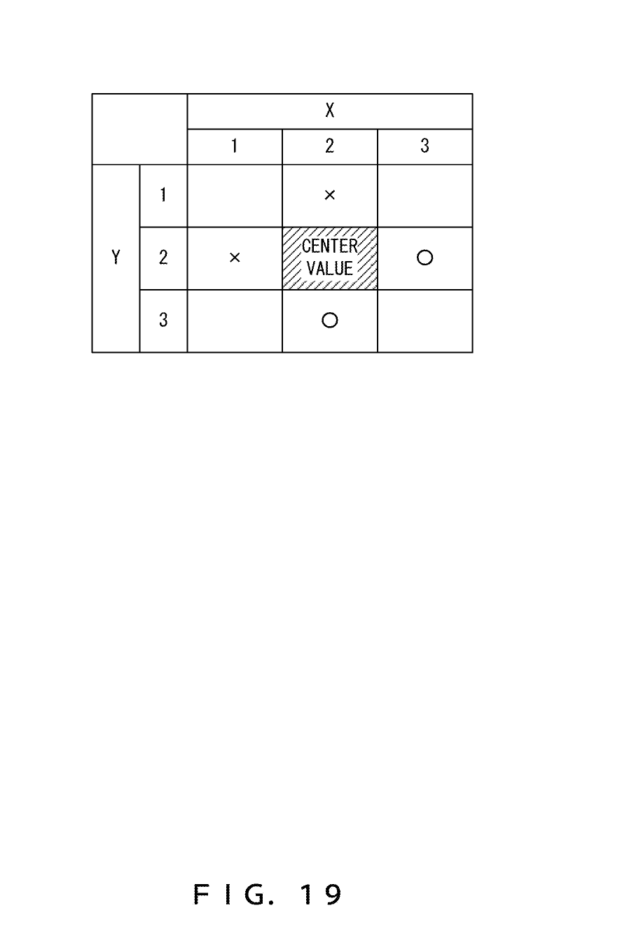

FIG. 19 is a diagram illustrating comparison results.

Since the eye widths of the peripheral values (center value+1, center value) and (center value−1, center value) are 22 and 17, respectively, it is determined that the peripheral value (center value+1, center value)=(3,2) is ∘, and it is determined that the peripheral value (center value−1, center value)=(1,2) is x.

Since the eye widths of the peripheral values (center value, center value+1) and (center value, center value−1) are 20 and 18, respectively, it is determined that the peripheral value (center value, center value+1)=(2,3) is ∘, and it is determined that the peripheral value (center value, center value−1)=(2,1) is x.

As a result, the result that is illustrated in FIG. 19 can be obtained.

Then, in FIG. 19, a point that is adjacent to the two ∘'s and that is other than the center point is set as an additional measurement point.

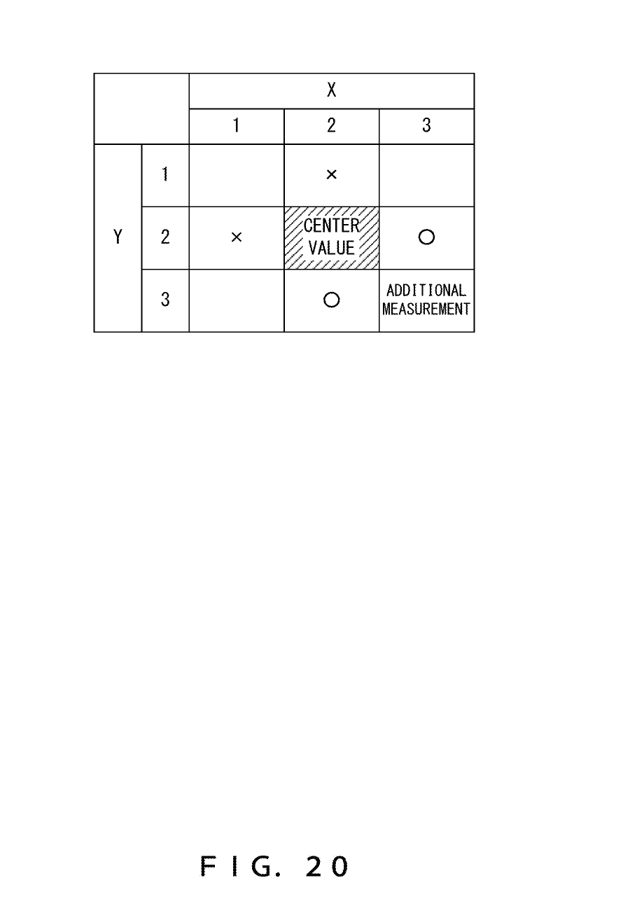

FIG. 20 is a diagram illustrating an additional measurement point.

The point that is other than the center value and that is adjacent to the peripheral values for which it is determined that they are ∘, i.e., (center value+1, center value)=(3,2) and (center value, center value+1)=(2,3) is (3,3).

As illustrated in FIG. 20, the point of (X,Y)=(3,3) is the additional measurement point.

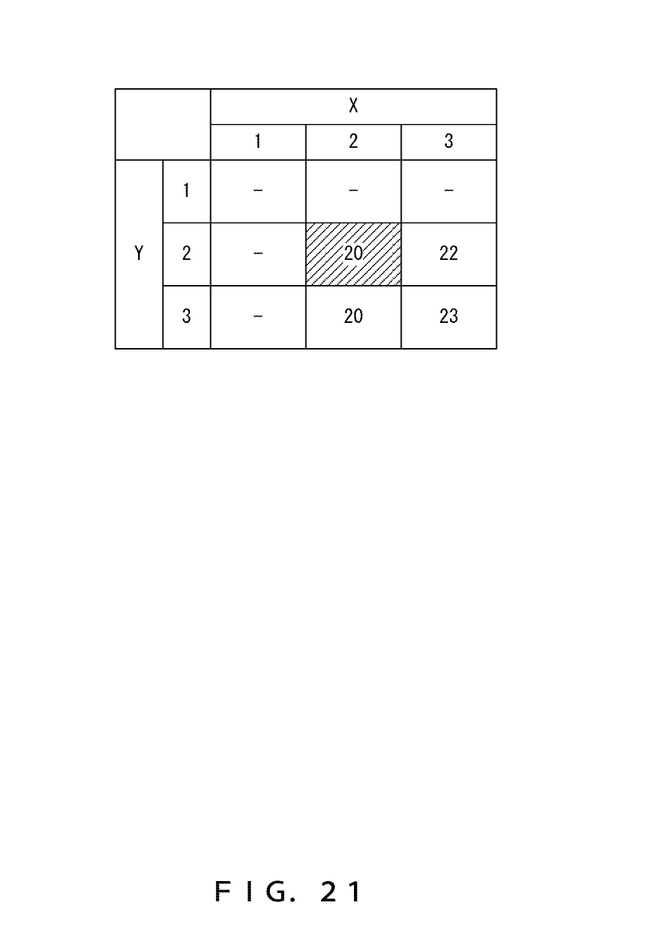

FIG. 21 is a diagram illustrating the result of additional measurement.

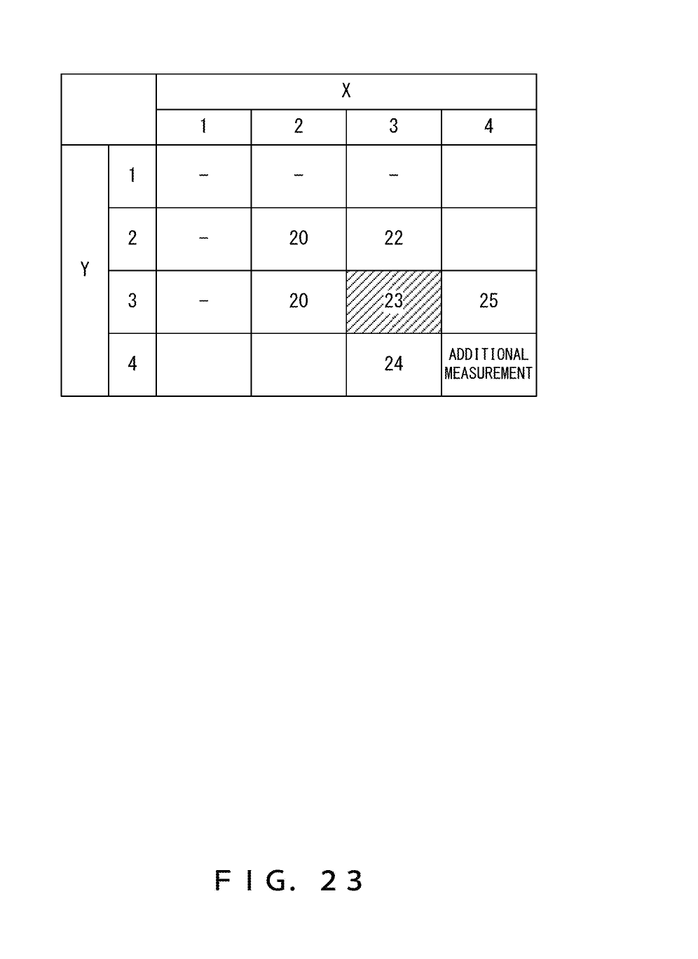

It is assumed that when the eye width of the additional measurement point is measured, the eye width of the additional measurement point is 23 as illustrated in FIG. 23.

The measurement results of the peripheral values that include the additional measurement point and the measurement result of the center value are compared, and a point with the largest measurement result is set as a new center value. When the measurement result of the center value is the largest value, the center value becomes the optimum value, and the optimization of parameters is finished.

As illustrated in FIG. 21, since the measurement result of (X,Y)=(3,3) is the largest value, (3,3) is set as the new center value.

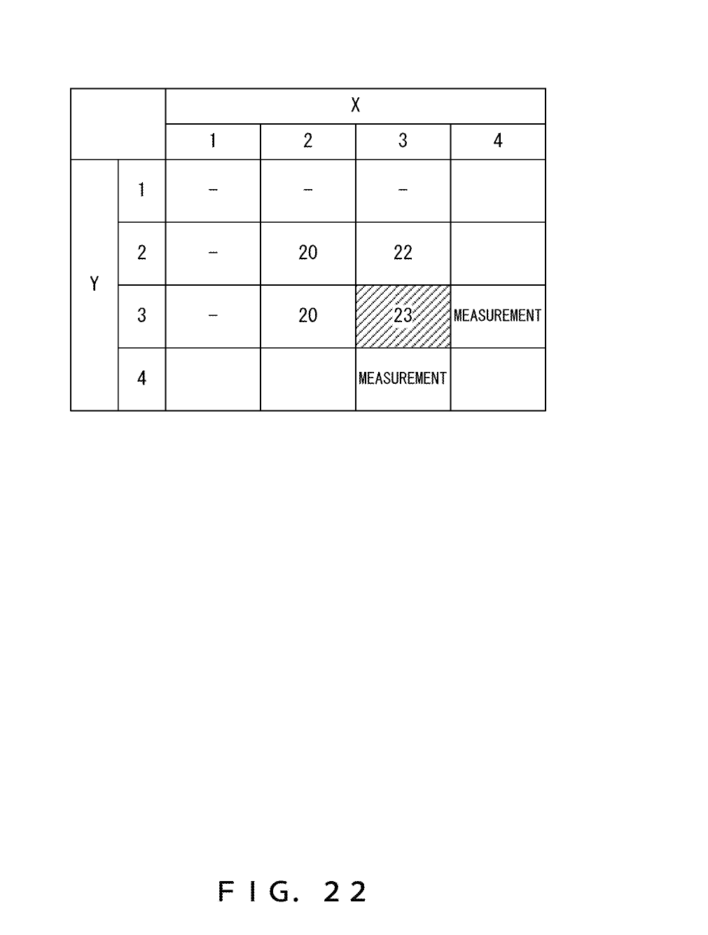

FIG. 22 is a diagram illustrating the new center value and measurement points.

FIG. 23 is a diagram illustrating an additional measurement point with respect to the new center value.

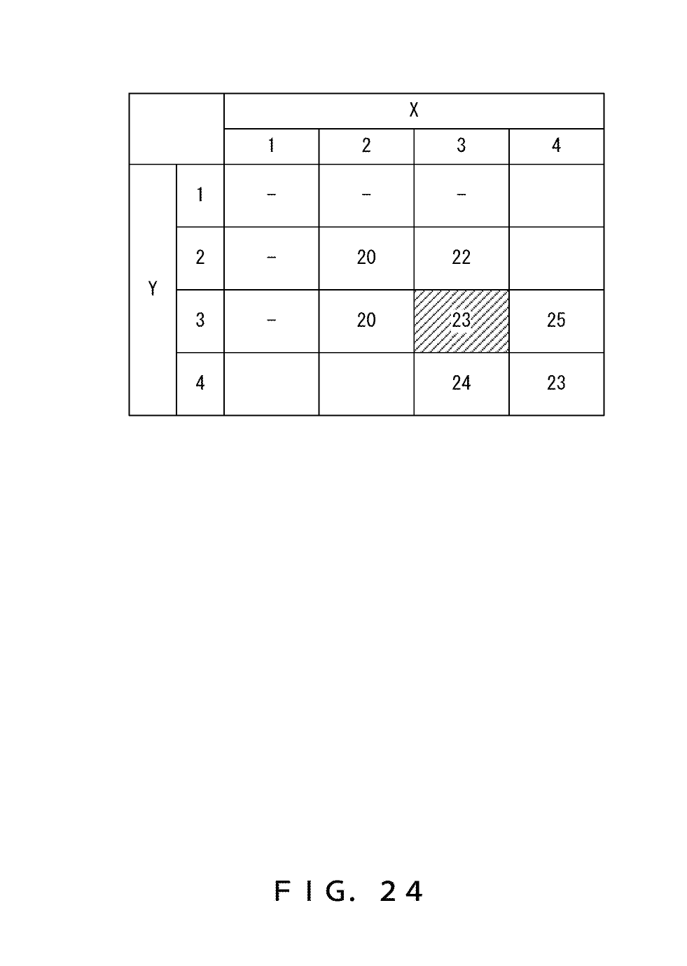

FIG. 24 is a diagram illustrating the result of additional measurement.

Hereinafter, in the same manner, the eye widths of the peripheral values of the new center value (X,Y)=(4,3), (3,4) are measured (FIG. 22), an additional measurement point is determined from the measurement result (FIG. 23), and the eye width of the additional measurement point (X,Y)=(4,4) is measured.

As a result of the additional measurement, the result illustrated in FIG. 24 is obtained.

When there are eye widths of peripheral values that have already been measured, measurement of the eye widths of the peripheral values is omitted.

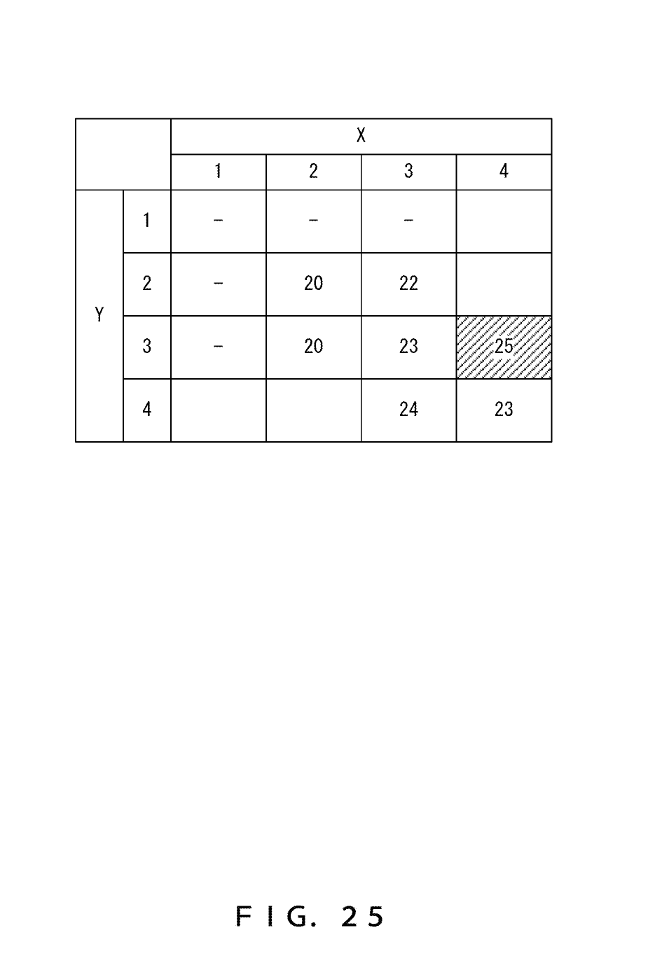

FIG. 25 is a diagram illustrating a new center value.

By the same process as that described above, a point with the largest eye width value is set as the new center value (X,Y)=(4,3) (FIG. 25).

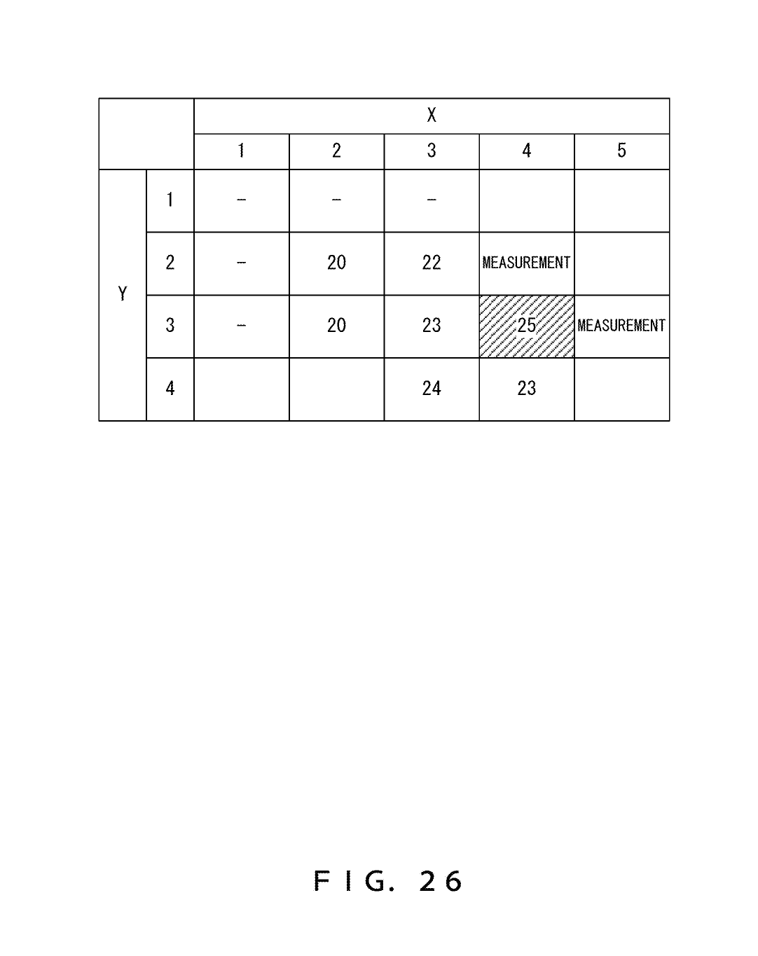

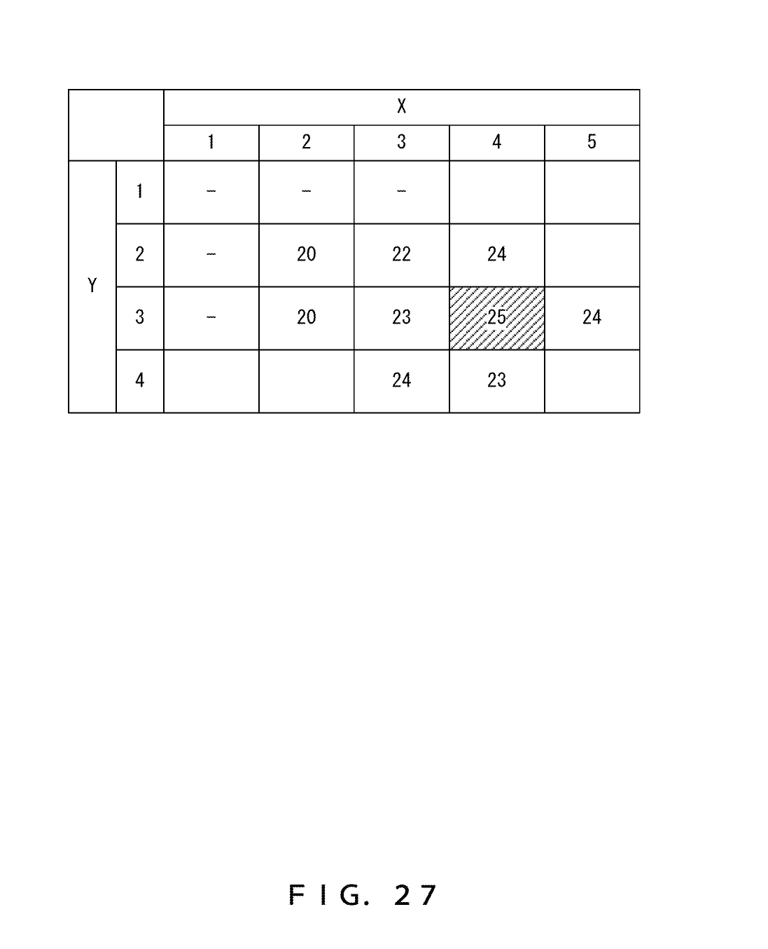

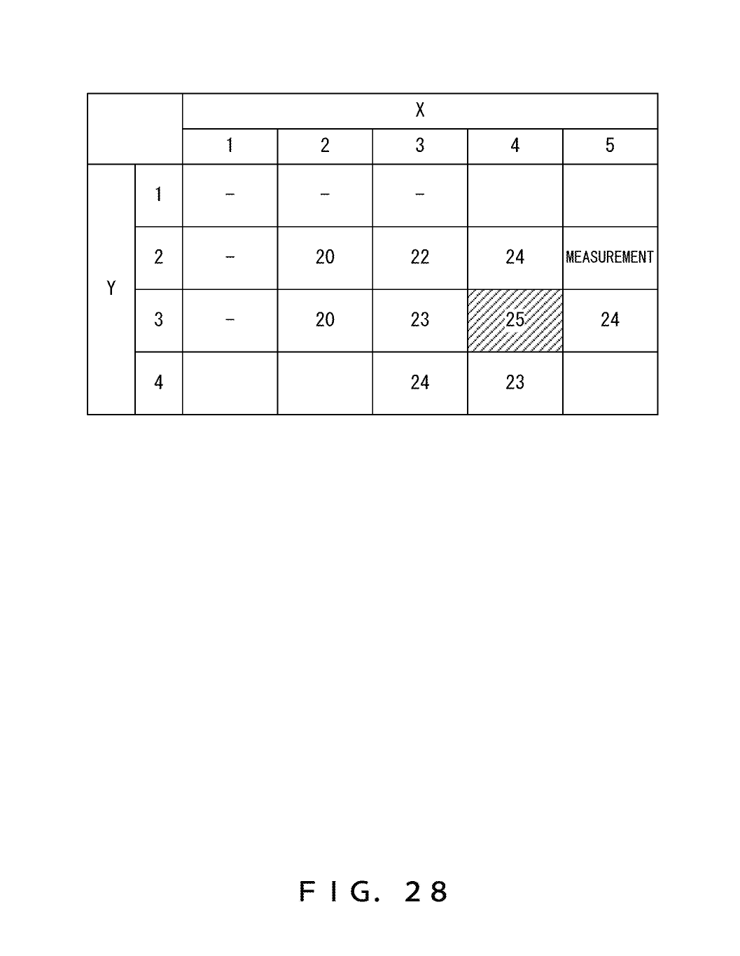

Hereinafter, in the same manner as in the above process, the eye widths of the peripheral values of the new center value (X,Y)=(4,2) and (5,3) are measured (FIG. 26), an additional measurement point is determined (FIG. 28) from the measurement results (FIG. 27), and the eye width of the additional measurement point (X,Y)=(5,2) is measured.

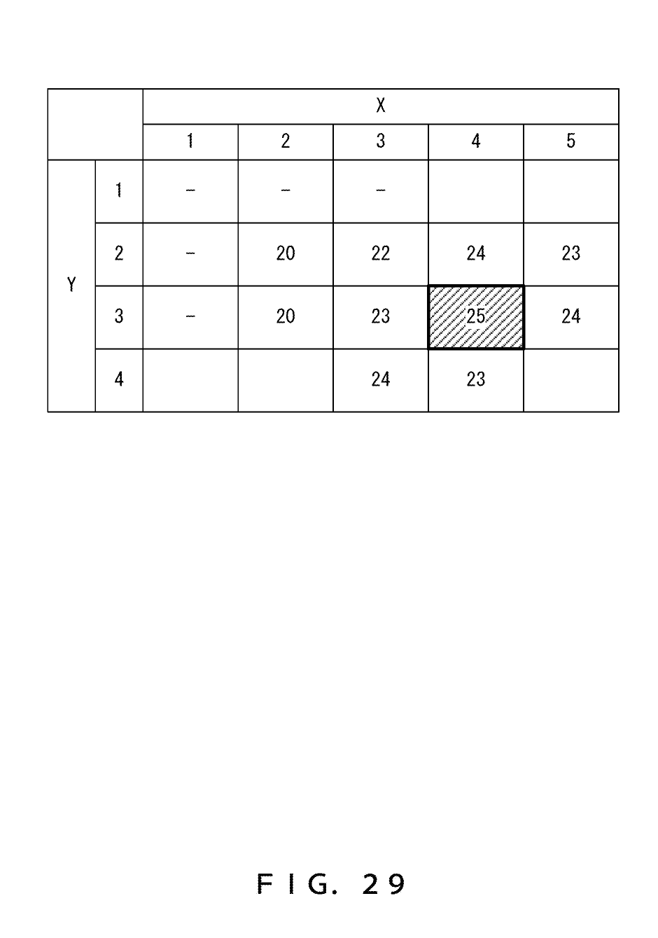

It is assumed that the result that is illustrated in FIG. 29 is obtained as a result of the above. Here, when the measurement results of the peripheral values that include the additional measurement point and the measurement result of the center value are compared with each other, since the measurement result (=25) of the center value (X,Y)=(4,3) is the largest value, the center value (X,Y)=(4,3) is set as the optimum value, and the process is terminated.

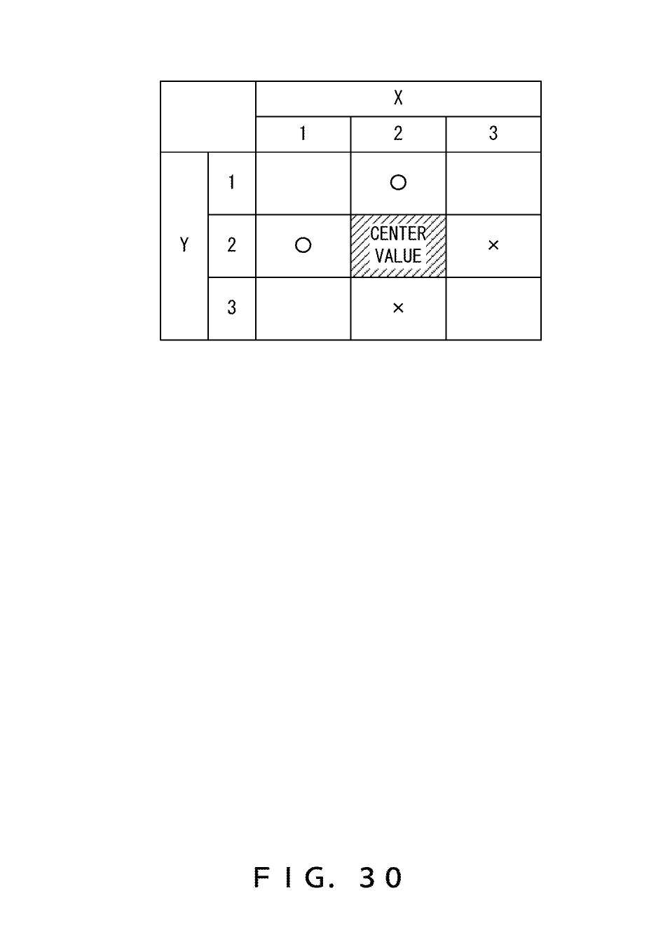

FIG. 30 is a diagram illustrating a first pattern of the comparison result of the eye widths of the peripheral values.

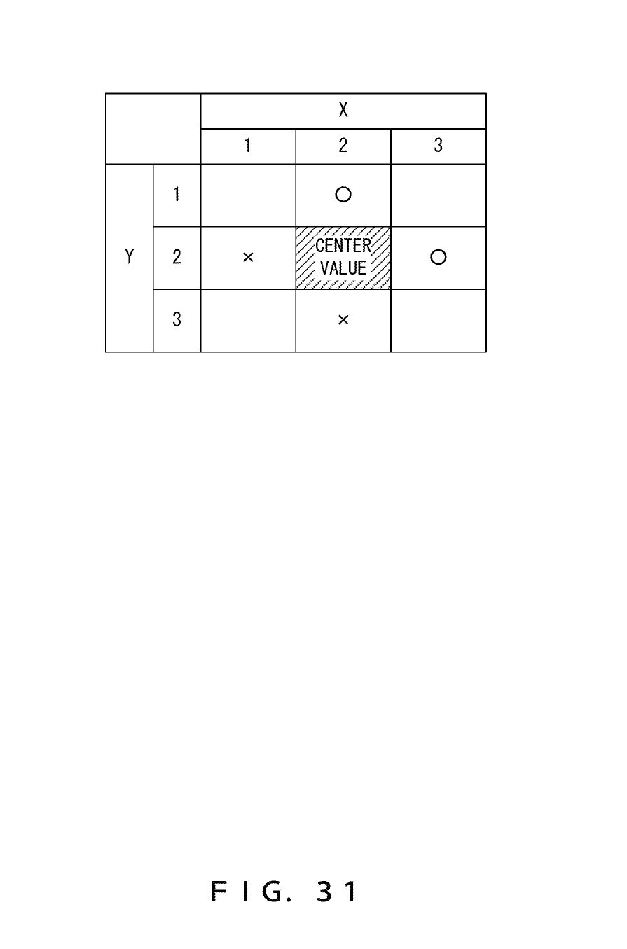

FIG. 31 is a diagram illustrating a second pattern of the comparison result of the eye widths of the peripheral values.

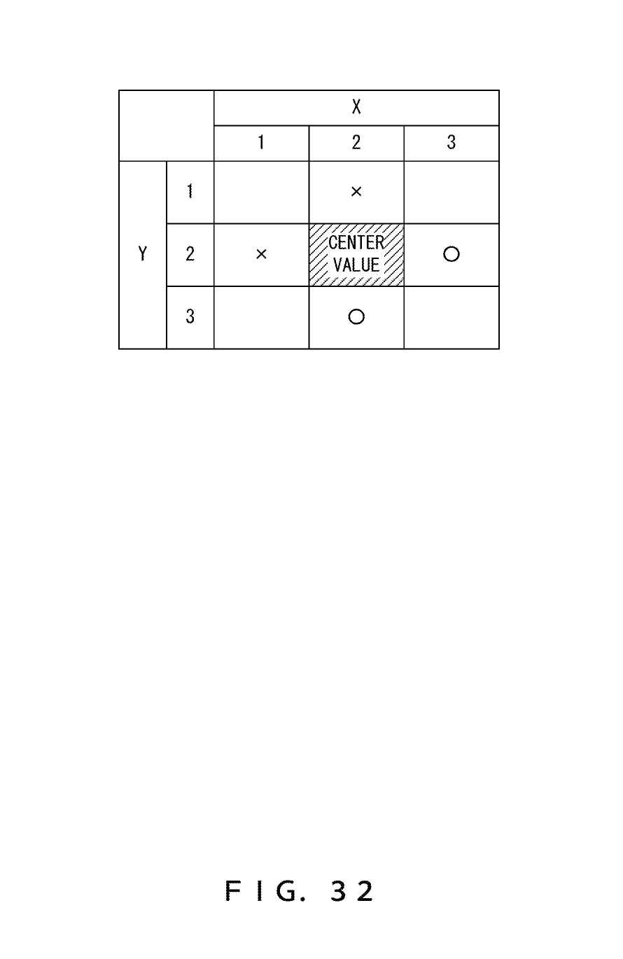

FIG. 32 is a diagram illustrating a third pattern of the comparison result of the eye widths of the peripheral values.

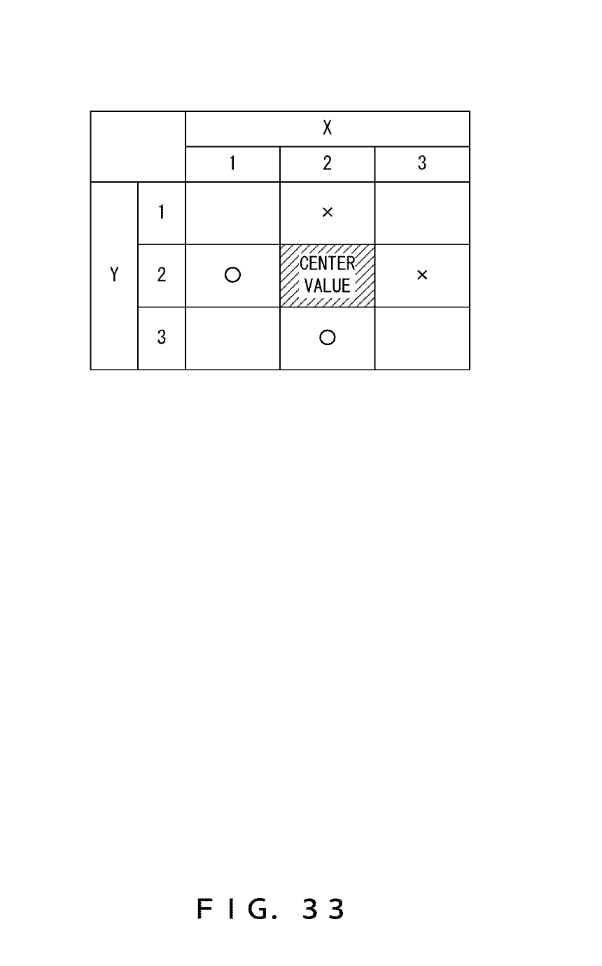

FIG. 33 is a diagram illustrating a fourth pattern of the comparison result of the eye widths of the peripheral values.

In FIGS. 30-34, it is set that the center value (X,Y)=(2,2).

In comparison of the eye widths of the peripheral values, when it is determined that each peripheral value is either ∘ or x, there are four patterns in the comparison result, as illustrated in FIGS. 30-33, and the optimum value can be obtained in the same manner in each of the patterns in FIGS. 30-33. In the patterns in FIGS. 30-33, the additional measurement points are (X,Y)=(1,1), (3,1), (3,3) and (1,3), respectively.

A case will be described wherein the measurement results of the peripheral values are the same value.

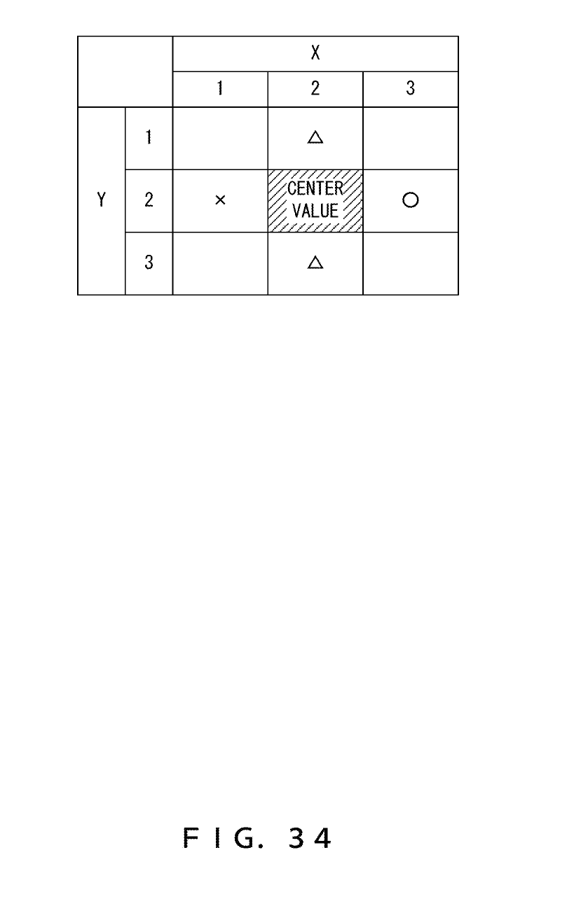

FIG. 34 is a diagram illustrating a comparison result when the measurement results of peripheral values are the same.

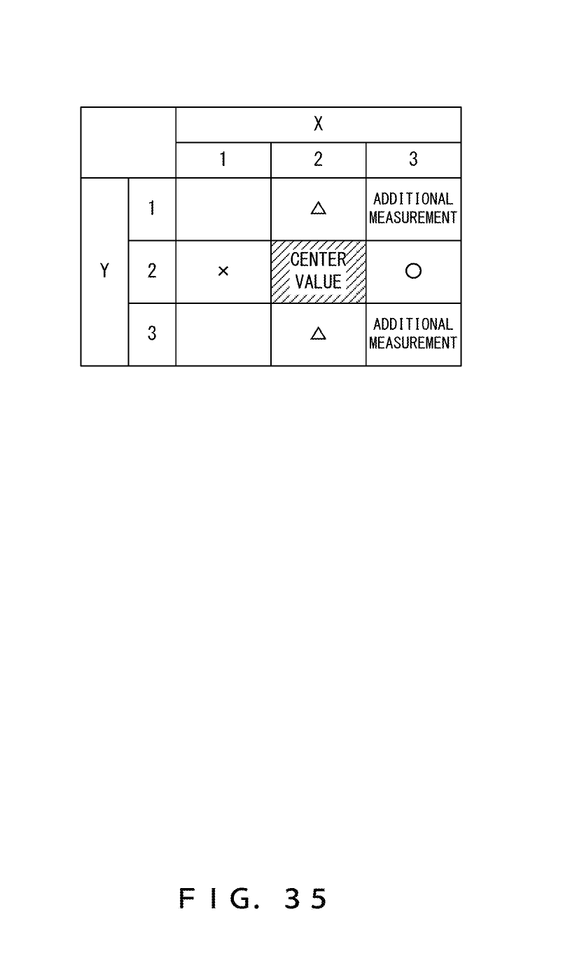

FIG. 35 is a diagram illustrating additional measurement points when the measurement results of the peripheral values are the same.

In FIGS. 34 and 35, it is set that the center value (X,Y)=(2,2). In addition, as a result of comparison, it is determined that the peripheral value (3,2) is ∘, and it is determined that the peripheral value (1,2) is X.

As illustrated in FIG. 34, when the measurement results of the peripheral values (center value, center value+1) and (center value, center value−1) are the same value, it is determined that both peripheral values are Δ, and two points that are other than the center value and that are adjacent to the determination result ∘ and the determination result Δ are determined to be additional measurement points, and additional measurement (measurement of the eye widths of the two additional measurement points) is performed.

As illustrated in FIG. 35, since the measurement results for the peripheral values (2,1) and (2,3) are the same, additional measurement is performed while setting as additional measurement points (3,1), which is adjacent to the peripheral value (3,2), the determination result for which is ∘, and to the peripheral value (2,1), and (3,3), which is adjacent to the peripheral value (3,2), the determination result for which is ∘, and to the peripheral value (2,3).

Hereinafter, the above pre-emphasis adjustment process will be described using a flowchart.

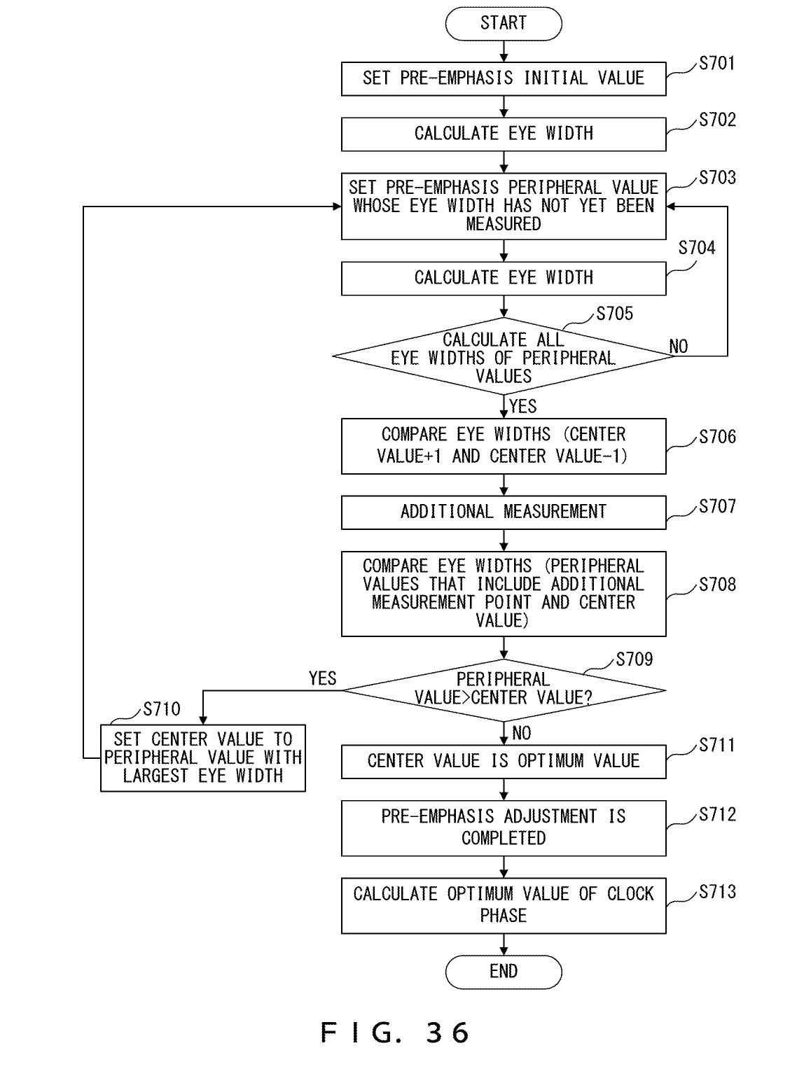

FIG. 36 is a flowchart of the pre-emphasis adjustment process according to the embodiments.

In step S701, the pre-emphasis adjustment unit 411 sets a pre-emphasis initial value. The pre-emphasis adjustment unit 411 outputs to the pre-emphasis setting unit 231 an instruction to set a pre-emphasis value to the initial value. The set initial value is set as a center value.

In step S702, the clock phase adjustment unit 421 calculates the eye width by the clock phase adjustment process (FIG. 15) when a pre-emphasis set value is the initial value.

In step S703, the pre-emphasis adjustment unit 411 sets as a measurement point one of the peripheral values whose eye widths have not yet been measured. Here, the peripheral value is a value that is obtained by shifting each parameter of the center value by +1 or −1. For example, when there are two parameters and the center value is (X,Y), there are four points that are the peripheral values, (X+1,Y), (X−1,Y), (X,Y+1) and (X, Y−1).

In step S704, the clock phase adjustment unit 421 calculates the eye widths of the set peripheral values by the clock phase adjustment process (FIG. 15).

In step S705, when the eye widths of all the peripheral values are already calculated, a control proceeds to step S706, and unless the eye widths of all the peripheral values are already calculated, the control returns to step S703.

In step S706, the pre-emphasis adjustment unit 411 compares the eye width of (center value+1) and the eye width of (center value−1) of each parameter. For example, when there are two parameters and the center value is (X,Y), the eye widths of (X+1,Y) and (X−1,Y) are compared with each other, and the eye widths of (X, Y+1) and (X, Y−1) are compared with each other.

In step S707, the pre-emphasis adjustment unit 411 determines an additional measurement point on the basis of the comparison result. The clock phase adjustment unit 421 determines the eye width of the additional measurement point.

In step S708, the pre-emphasis adjustment unit 411 compares the eye width of each peripheral value with the eye width of the center value. Here, the peripheral values include values that are obtained by shifting each parameter of the above center value by +1 or −1 and the point that is determined as the additional measurement point.

In step S709, when any of the eye widths of the peripheral values is larger than the eye width of the center value, a control proceeds to step S710, and when none of the eye widths of the peripheral values is larger than the eye width of the center value, the control proceeds to step S711.

In step S710, the pre-emphasis adjustment unit 411 sets the peripheral value with the largest eye width as a new center value in the comparison in step S708.

In step S711, the pre-emphasis adjustment unit 411 sets the center value as the optimum value of pre-emphasis parameters.

In step S712, the pre-emphasis adjustment unit 411 outputs to the pre-emphasis setting unit 231 an instruction to set the pre-emphasis parameters to the above optimum value. The pre-emphasis setting unit 231 sets the pre-emphasis parameters of the transmission unit 241 as the optimum value.

In step S713, the clock phase adjustment unit 421 calculates an optimum value of a clock phase. The optimum value Tn of the clock phase is calculated by dividing by 2 the difference between the left end T0 of the eye width and the right end T1 of the eye width when the pre-emphasis parameters are the optimum value. That is, Tn=(T1−T0)/2. The clock phase adjustment unit 421 outputs to the clock phase setting unit 361 an instruction to set the clock phase to the optimum value.

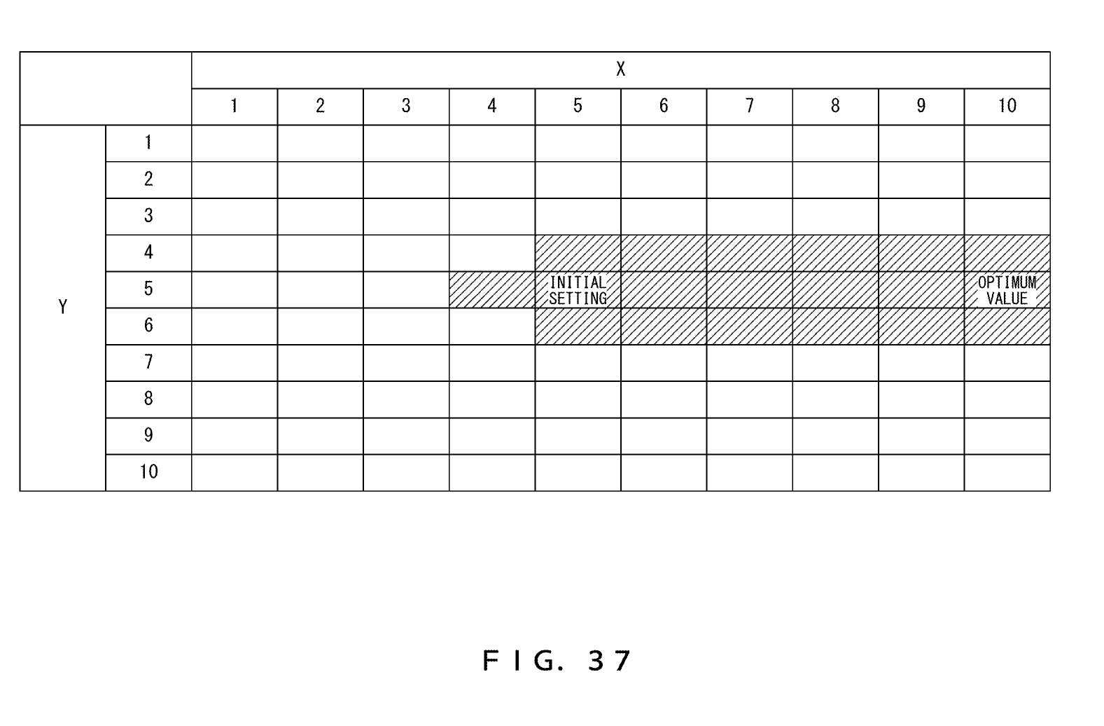

FIG. 37 is a diagram illustrating pre-emphasis set values whose eye widths are measured.

FIG. 37 illustrates a case in which an initial set value is (X,Y)=(5,5), an optimum value is (10,5), and additional measurement is once for each time (∘x determination can be made by comparison of center value±1), and there are 19 set values to be measured. Shaded areas in FIG. 37 show portions that have been measured.

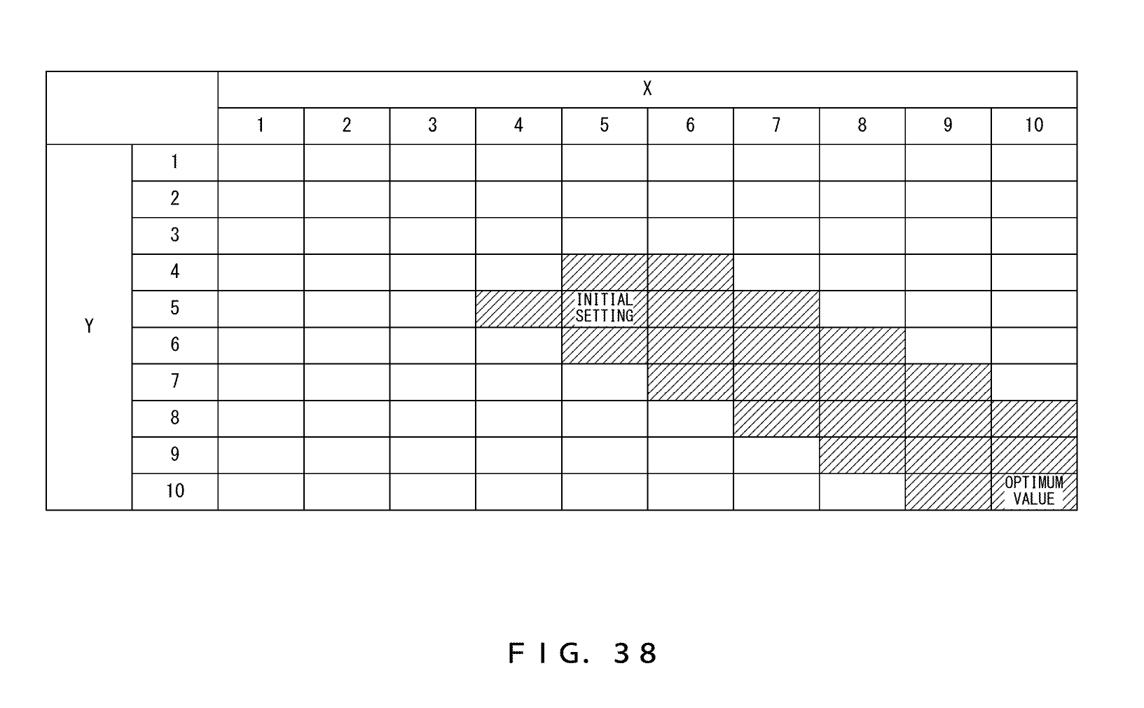

FIG. 38 is a diagram illustrating pre-emphasis set values whose eye widths are measured.

FIG. 38 illustrates a case in which an initial set value is (X,Y)=(5,5), an optimum value is (10,10), and additional measurement is twice for each time (Δ determination is made by comparison of center value±1), and there are 23 set values to be measured. Shaded areas in FIG. 38 show portions that have been measured.

For example, when second-order pre-emphasis parameters are adjusted, 100 patterns of measurement are necessary in a conventional method when 10 patterns of setting are possible for one parameter. On the other hand, according to the pre-emphasis adjustment process of the embodiments that use local search, an optimum set value can be obtained by measurement of 23 patterns at maximum. Man-hours can be cut down by 77% (77 patterns).

Next, a case will be described in which there are third-order (three) pre-emphasis parameters.

When pre-emphasis consists of third-order parameters, an optimum value can be obtained in the same manner as in the case of second-order parameters.

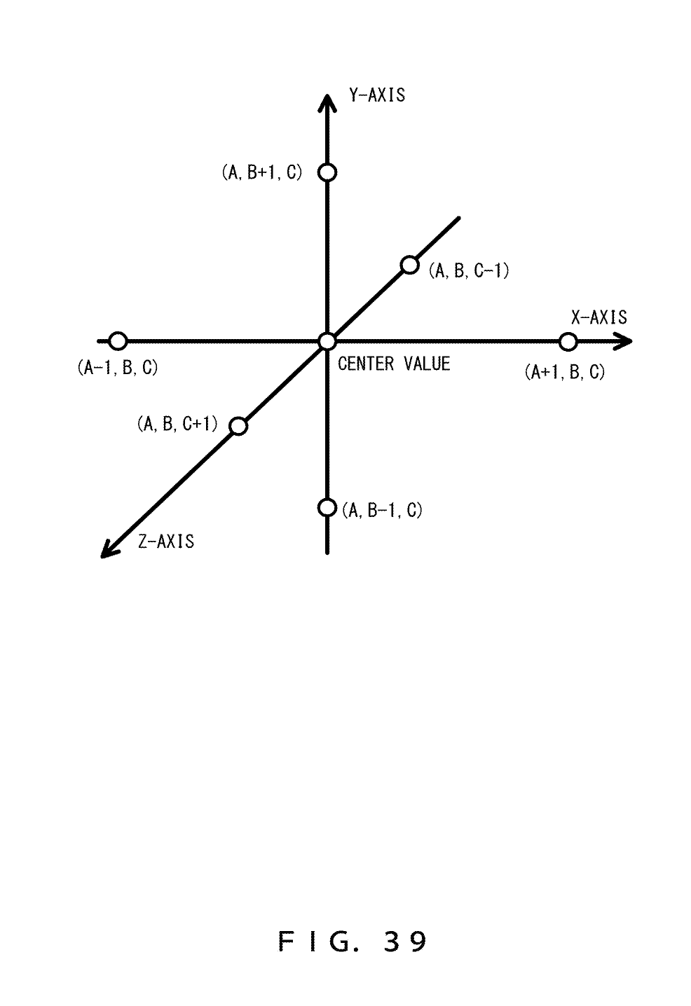

FIG. 39 is a diagram illustrating initial measurement points of third-order parameters.

As illustrated in FIG. 39, a center value (X,Y,Z)=(A,B,C) is set as an initial value, and the eye width of each measurement value is measured while setting as measurement points seven points, the center value and the peripheral values (X,Y,Z)=(center value±1, center value, center value) (center value, center value±1, center value) and (center value, center value, center value±1).

Measurement results of the peripheral values (center value+1, center value, center value) and (center value−1, center value, center value), measurement results of the peripheral values (center value, center value+1, center value) and (center value, center value−1, center value), and measurement results of the peripheral values (center value, center value, center value+1) and (center value, center value, center value−1) are compared with each other, respectively. A larger measurement result is set to be ∘ (large), a smaller result is set to be x (small), and the results are set to be Δ when they are the same value at compared measurement points, and an additional measurement point is determined.

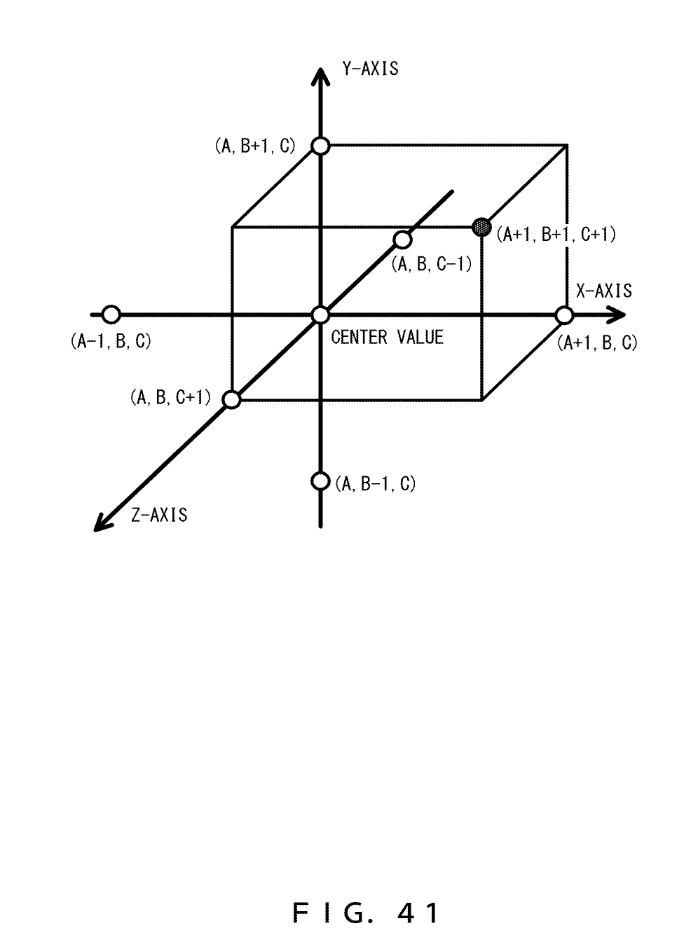

FIG. 41 is a diagram illustrating a determination result of a third-order parameter.

FIG. 41 is a diagram illustrating an additional measurement point.

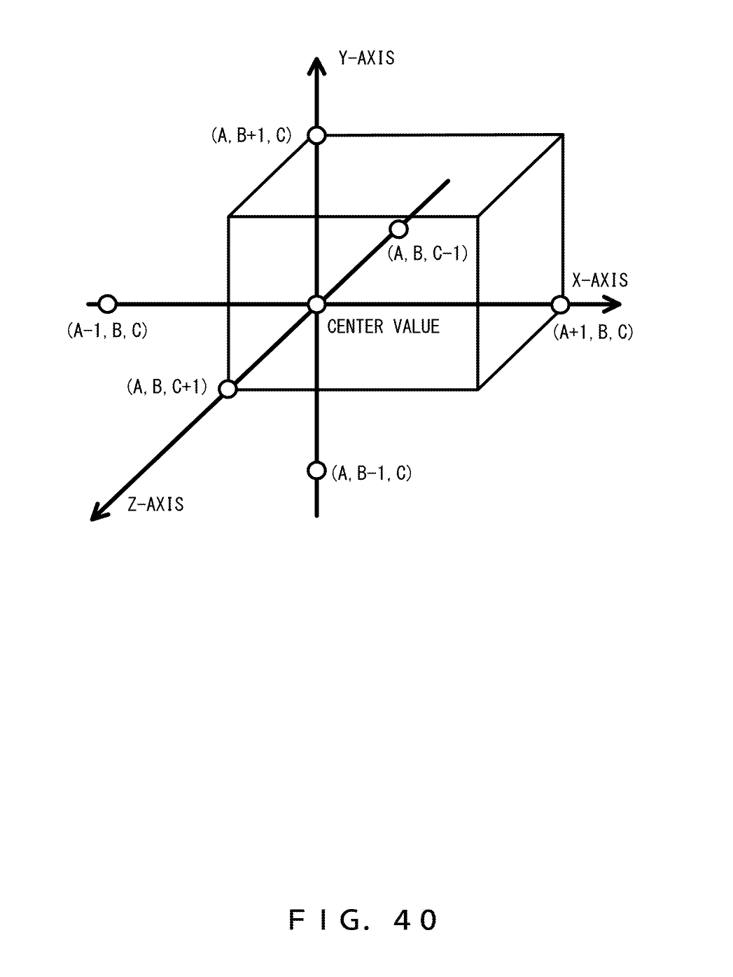

Here, it is assumed that (center value+1, center value, center value), (center value, center value+1, center value) and (center value, center value, center value+1) are ∘. A cube in FIG. 40 shows an area in which each parameter is determined to be ∘.

As illustrated in FIG. 41, since the additional measurement point is a set value (center value+1, center value+1, center value+1)=(A+1,B+1,C+1), the eye width of the set value (center value+1, center value+1, center value+1)=(A+1,B+1,C+1) is additionally measured.

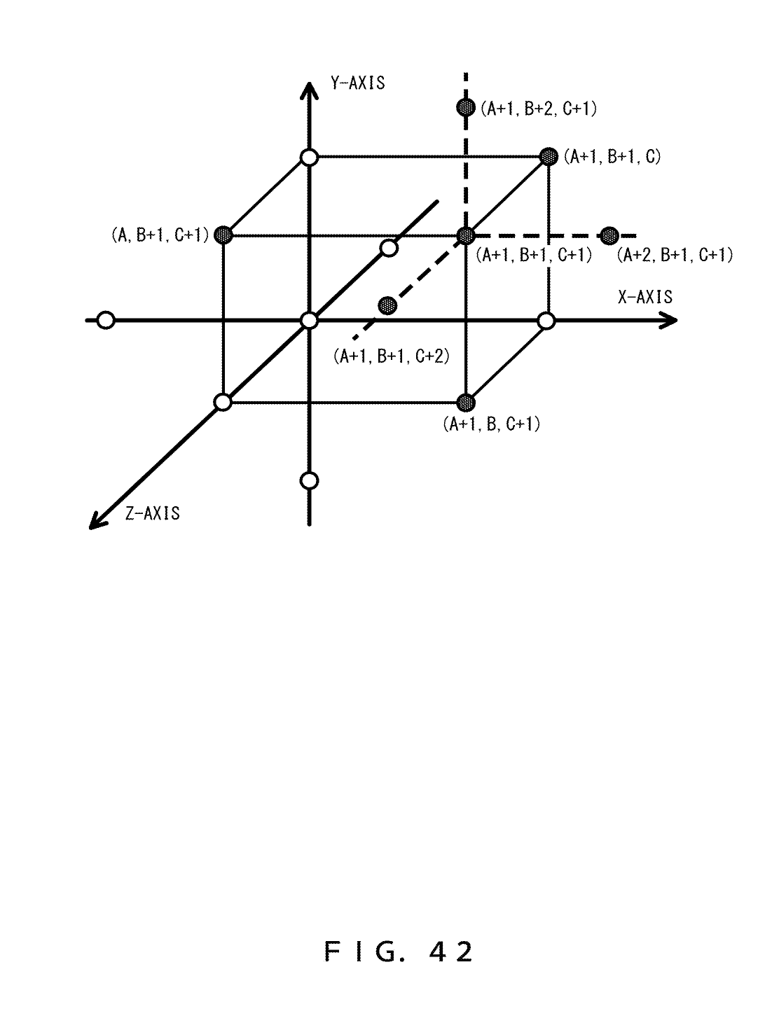

FIG. 42 is a diagram illustrating measurement points with respect to a new center value.

In measurement results of peripheral values that include additional measurement, when it is assumed that a measurement point with the largest value of the measurement result is the set value (center value+1, center value+1, center value+1)=(A+1,B+1,C+1), the new center value is set as (A+1,B+1,C+1).

As illustrated in FIG. 42, there are six measurement points (peripheral values), (A+2,B+1,C+1), (A,B+1,C+1), (A+1,B+1,C), (A+1,B+1,C+2), (A+1,B+2,C+1), (A+1,B,C+1) with respect to the new center value. The eye width of each measurement point is measured. When there is a measurement point that has already been measured, the measurement thereof is omitted.

Measurement results of the center value±1 of each parameter are compared with each other, the larger value of the measurement results is set to be ∘, the smaller value is set to be x, and a set value adjacent to the determination result ∘ of each parameter is additionally measured.

When the measurement results are Δ, set values adjacent to set values of the center value±1 of the parameter and a determination ∘ of the other parameters are additionally measured.

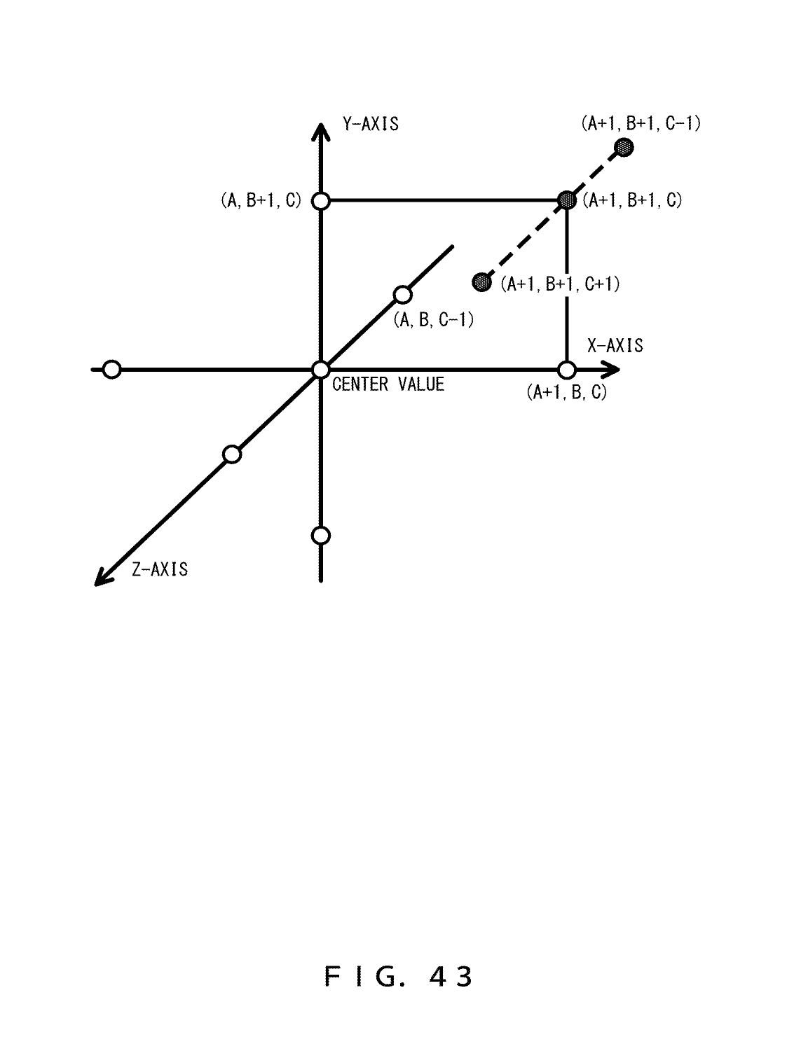

FIG. 43 is a diagram illustrating additional measurement points when the determination result of one parameter is equal.

When the determination value of a parameter Z is Δ (that is, when the determination result of (center value, center value, center value+1) and the determination result of (center value, center value, center value−1) are the same), two points, (A+1,B+1,C−1) and (A+1,B+1,C+1), are determined to be additional measurement points as illustrated in FIG. 43, and are additionally measured.

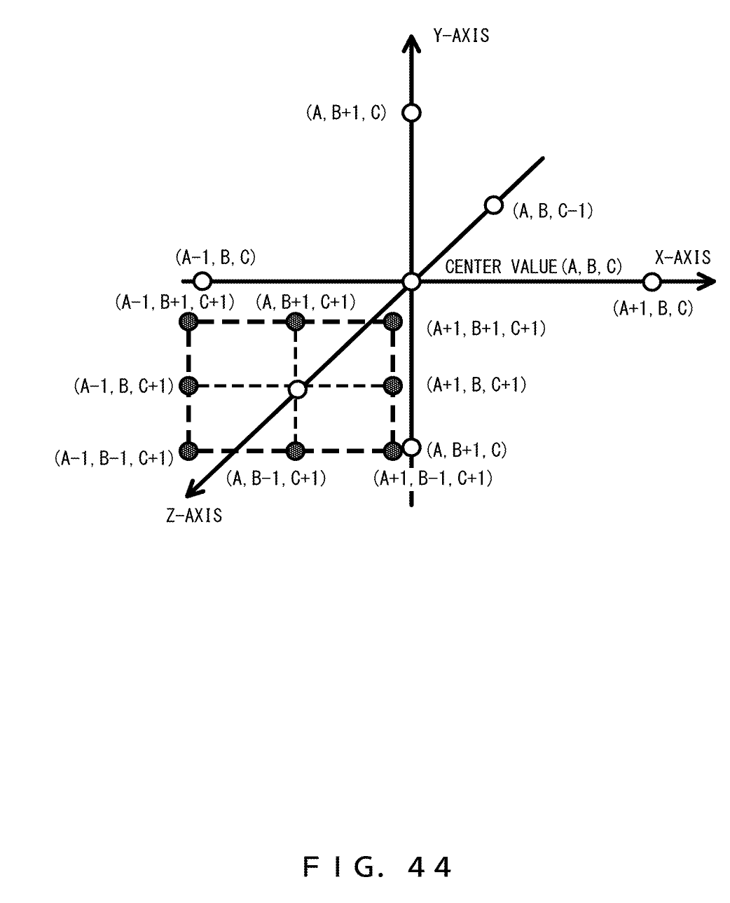

FIG. 44 is a diagram illustrating additional measurement points when determination results of two parameters are equal.

When both determination values of parameters X and Y are Δ, and when it is assumed that determination results of (A,B,C+1) and (A,B,C−1) are ∘ and x, respectively, as illustrated in FIG. 44, there are eight additional measurement points, (A+1,B,C+1), (A+1,B+1,C+1), (A,B,C+1), (A−1,B+1,C+1), (A−1,B,C+1), (A−1,B−1,C+1), (A,B−1,C+1), and (A+1,B−1,C+1), and additional measurement is performed.

Respective measurement results of the additional measurement points, the peripheral values and the center value are compared, and the above measurement is repeated until the measurement result of the center value becomes the largest value.

A case in which parameters to be adjusted are of a fifth-order is explained.

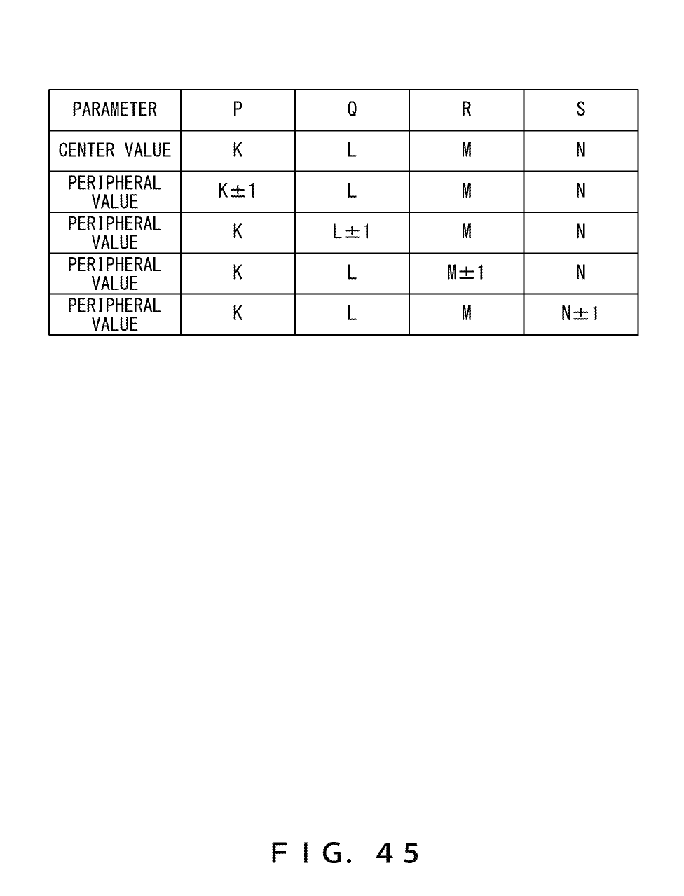

FIG. 45 is a diagram illustrating measurement points.

For example, when pre-emphasis variables P, Q, and R, a clock phase, and an equalizer variable S are simultaneously adjusted, the center value of measurement points (set values) is set as (P,Q,R,S)=(K,L,M,N), as illustrated in FIG. 45.

As illustrated in FIG. 45, there are eight points that are the peripheral values, (P,Q,R,S)=(K±1,L,M,N), (K,L±1,M,N), (K,L,M±1,N) and (K,L,M,N±1).

Measurement results of (K−1,L,M,N) and (K+1,L,M,N), measurement results of (K,L−1,M,N) and (K1,L+1,M,N), measurement results of (K,L,M−1,N) and (K1,L,M+1,N) and measurement results of (K,L,M,N−1) and (K1,L,M,N+1) are measured with each other, respectively. That is, the measurement results of the center value±1 of each parameter are compared with each other.

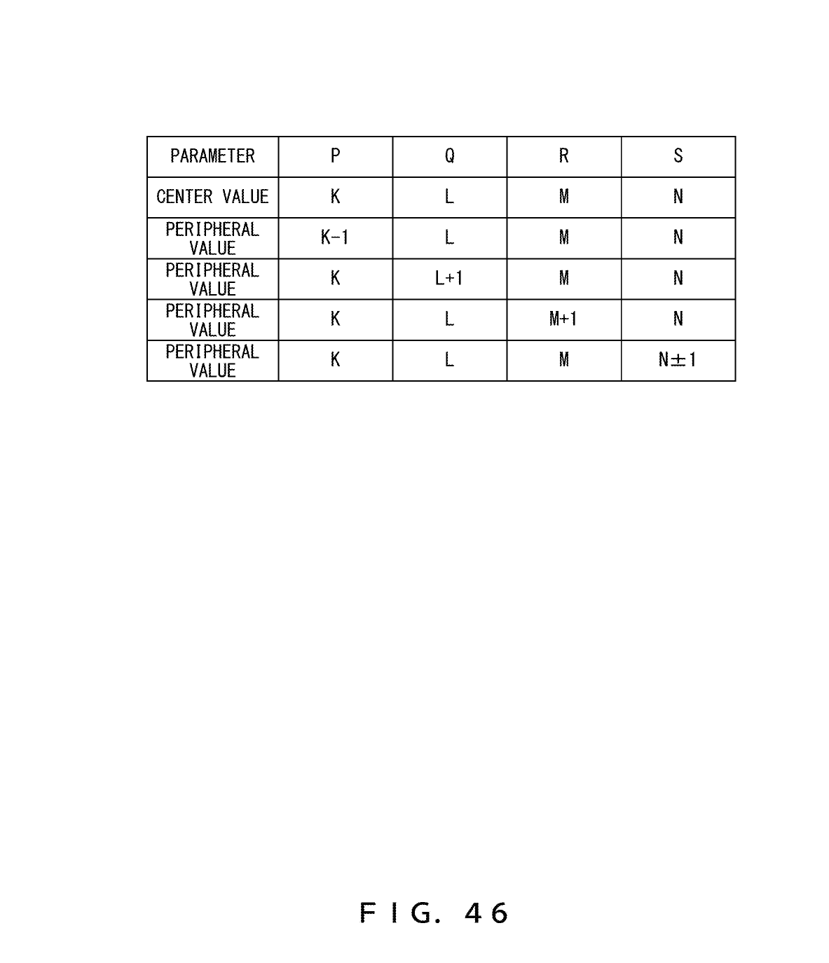

FIG. 46 is a diagram illustrating measurement points with a large or equal measurement result.

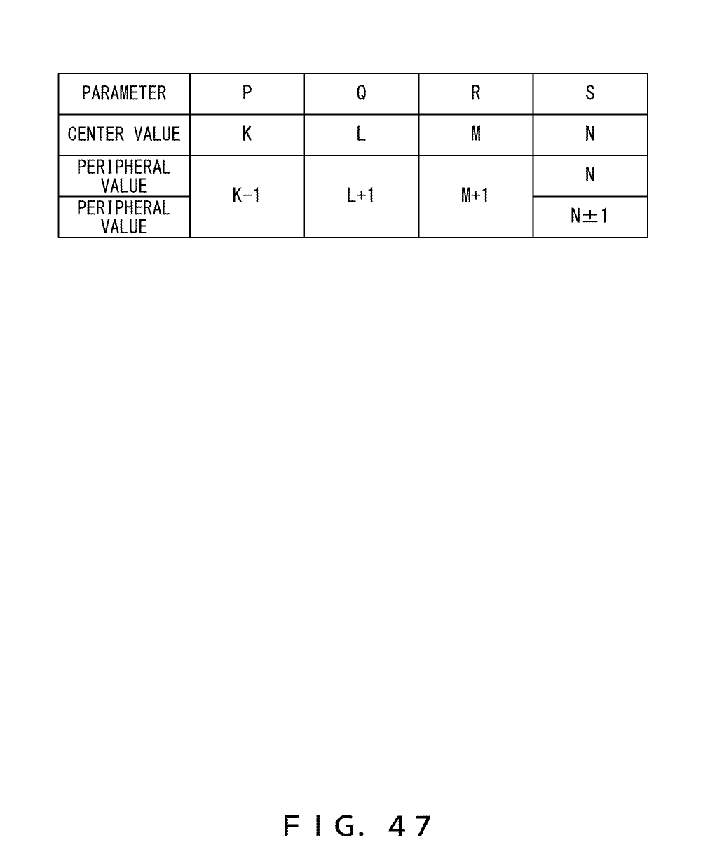

FIG. 47 is a diagram illustrating additional measurement points.

As a result of comparison, as illustrated in FIG. 46, when it is assumed that the measurement results of (K−1,L,M,N), (K,L+1,M,N) and (K,L,M+1,N) are larger values in each parameter and are determined to be ∘, and when it is assumed that the measurement results of (K,L,M,N−1) and (K,L,M,N+1) are the same value and are determined to be Δ, there are three points that are additional measurement points, (K−1,L+1,M+1,N) and (K−1,L+1,M+1,N±1), as illustrated in FIG. 47. That is, measurement points adjacent to the center value or the center value±1 of the parameter with a determination Δ, and adjacent to determination result ∘ are additionally measured.

In the peripheral values that include additional measurement, a measurement point (set value) with the largest value of the measurement result is set as a new center value.

Hereinafter, the above process is repeated until the measurement result of the center value becomes a larger value than the measurement results of the peripheral values, and an optimum value is calculated.

An example of a fifth parameter S is a setting of a gain and a band of clock data recovery (CDR), in addition to equalizer setting in the reception device 301. When parameters of the reception device 301 such as an equalizer, a gain or CDR are adjusted, the control device 401 includes an adjustment unit that adjusts these parameters and outputs an adjustment instruction to the reception device 301, and the reception device 301 adjusts the parameters on the basis of the received adjustment instruction.

By using the above method, an optimum value can be obtained in the same manner even if there are fifth-order or greater parameters.

According to the information processing system of the embodiments, the eye diagram width can be calculated quickly by omitting redundant measurement.

According to the information processing system of the embodiments, an optimum value of a parameter for pre-emphasis or a clock phase, etc. can be calculated quickly by omitting redundant measurement.

That is, according to the information processing system of the embodiments, a time that is taken for adjusting a parameter that is used in data communication is reduced.

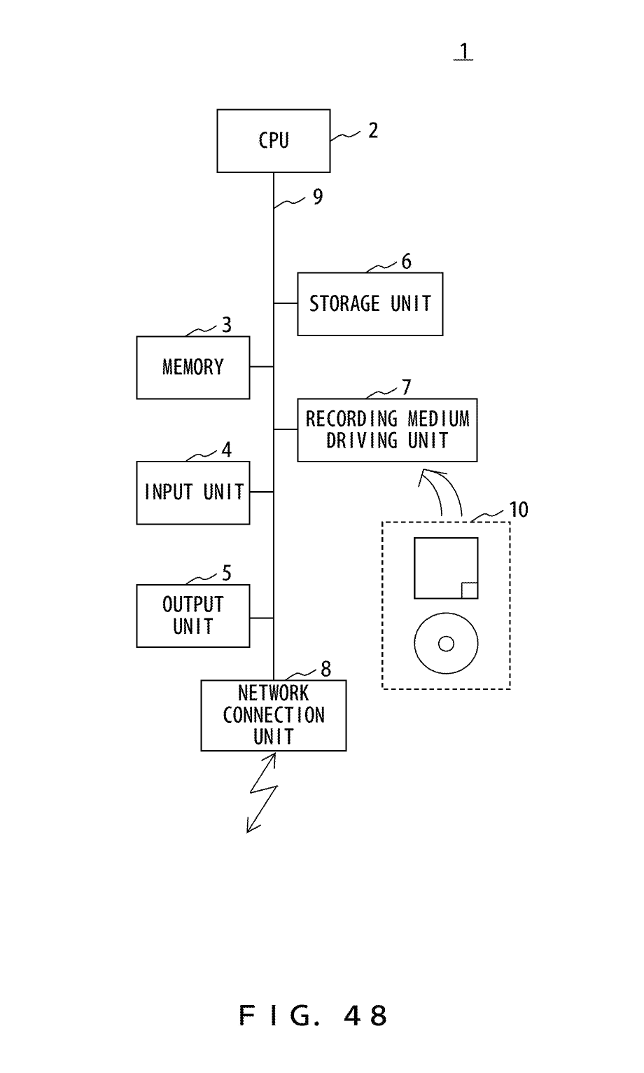

FIG. 48 is a configuration diagram of an information processing device (computer).

The control device 401 of the embodiments is realized by, for example, the information processing device 1 as illustrated in FIG. 48.

The information processing device 1 includes a Central Processing Unit (CPU) 2, a memory 3, an input unit 4, an output unit 5, a storage unit 6, a recording medium driving unit 7, and a network connection unit 8, and they are connected with one another through a bus 9.

The CPU 2 is a central processor that controls the entirety of the information processing device 1. The CPU 2 corresponds to the pre-emphasis adjustment unit 411 and the clock phase adjustment unit 421.

The memory 3 is a memory such as a Read Only Memory (ROM) and a Random Access Memory (RAM) that temporarily stores a program or data that is stored in the storage unit 6 (or a portable recording medium 10) at program execution. The CPU 2 executes the above various processes by executing the program by using the memory 3. The memory 3 corresponds to the storage unit 431.

In this case, a program code itself that is read out from the portable recording medium 10, etc. realizes functions of the embodiments.

Examples of the input unit 4 include a keyboard, a mouse, and a touch panel.

Examples of the output unit 5 include a display and a printer.

Examples of the storage unit 6 include a magnetic disk device, an optical disk device, a tape device, and a non-volatile memory. The information processing device 1 stores the above program and data in the storage unit 6, and reads them out in the memory 3 and uses them as necessary.

The recording medium driving unit 7 drives the portable recording medium 10, and accesses its recording content. As the portable recording medium, an optional computer-readable recording medium is used. Examples of the computer-readable recording medium include a memory card, a flexible disk, a Compact Disk Only Memory (CD-ROM), an optical disk, and a magneto-optical disk. A user stores the above program and data in the portable recording medium 10, and reads them out in the memory 3 and uses them as necessary.

The network connection unit 8 is connected to an optional communication network such as a LAN and a WAN, and performs data conversion that accompanies communication.

All examples and conditional language provided herein are intended for pedagogical purposes to aiding the reader in understanding the invention and the concepts contributed by the inventor to further the art, and are not to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a transmission device configured to generate a transmission signal by adjusting a signal for transmitting data on the basis of a pre-emphasis parameter, and to transmit the transmission signal;
a reception device configured to receive the transmission signal, to generate reception data from the transmission signal on the basis of a clock signal, and to count a number of errors of the reception data; and
a processor configured to execute a process, the process comprising:
setting a first center value as an initial value for the pre-emphasis parameter;
calculating an eye diagram width of the first center value, and calculating an eye diagram width of each peripheral value of a plurality of peripheral values in respect to the first value;
comparing the eye diagram width of the first center value and the eye diagram width of each peripheral value;
repeating, when any of the eye diagram widths of the peripheral values is larger than the eye diagram width of the first center value, a process for setting as the first center value a peripheral value that corresponds to a largest eye diagram width in the eye diagram widths of the peripheral values, a process for calculating the eye diagram width of each peripheral value, and the comparing process until the eye diagram width of the first center value becomes larger than the eye diagram width of each peripheral value; and
setting the parameter as the first center value when the eye diagram width of the first center value is larger than the eye diagram width of each peripheral value, and setting as the phase an average value of a right end and a left end of the eye diagram width of the first center value.

2. The information processing system according to claim 1, wherein the processor
sets a second center value as an initial value for the phase,
sets the phase to the second center value, a first peripheral value that is adjacent to the second center value in a minus direction, and a second peripheral value that is adjacent to the second center value in a plus direction, and measures a number of errors of the second center value, a number of errors of the first peripheral value, and a number of errors of the second peripheral value,
sets a phase in which a number of errors is newly measured on the basis of the number of errors of the second center value, the number of errors of the first peripheral value, and the number of errors of the second peripheral value, and
calculates a right end and a left end of a phase range in which a number of errors is 0, and calculating an eye diagram width from the right end and the left end.

3. The information processing system according to claim 2, wherein the processor
compares a pre-emphasis parameter that is set in a previous process for calculating an eye diagram width and a pre-emphasis parameter that is set in this process, and
calculates an initial value for the phase that is used when a right end and a left end of a phase range in which a number of errors that is calculated in this process is 0, on the basis of a right end and a left end that are calculated in the previous process and a comparison result.

4. A parameter adjustment method that is executed by a processor of an information processing system that includes a transmission device that generates a transmission signal by adjusting a signal for transmitting data on the basis of a pre-emphasis parameter and transmits the transmission signal, a reception device that receives the transmission signal, generates reception data from the transmission signal on the basis of a clock signal, and counts a number of errors of the reception data, and the processor that adjusts the pre-emphasis parameter and a phase of the clock signal, the parameter adjustment method comprising:
setting, by a processor, a first center value as an initial value for the parameter;
calculating, by the processor, an eye diagram width of the first center value;
calculating, by the processor, an eye diagram width of each peripheral value of a plurality of peripheral values;
comparing, by the processor, the eye diagram width of the first center value and the eye diagram width of each peripheral value;
repeating, by the processor, when any of the eye diagram widths of the peripheral values is larger than the eye diagram width of the first center value, a process for setting as the first center value a peripheral value that corresponds to a largest eye diagram width in the eye diagram widths of the peripheral values, a process for calculating the eye diagram width of each peripheral value, and the comparing process until the eye diagram width of the first center value becomes larger than the eye diagram width of each peripheral value; and
setting, by the processor, the parameter as the first center value when the eye diagram width of the first center value is larger than the eye diagram width of each peripheral value, and setting as the phase an average value of a right end and a left end of the eye diagram width of the first center value.

5. The parameter adjustment method according to claim 4, comprising in the calculating the eye diagram width of the first center value or the calculating the eye diagram width of each peripheral value of the plurality of peripheral values:
setting a second center value as an initial value for the phase;
setting the phase to the second center value, a first peripheral value that is adjacent to the second center value in a minus direction, and a second peripheral value that is adjacent to the second center value in a plus direction, and measuring a number of errors of the second center value, a number of errors of the first peripheral value, and a number of errors of the second peripheral value;
setting a phase in which a number of errors is newly measured on the basis of the number of errors of the second center value, the number of errors of the first peripheral value, and the number of errors of the second peripheral value; and
calculating a right end and a left end of a phase range in which a number of errors is 0, and calculating an eye diagram width from the right end and the left end.

6. The parameter adjustment method according to claim 5, comprising in the calculating the eye diagram width of each peripheral value of the plurality of peripheral values:
comparing a pre-emphasis parameter that is set in a previous process for calculating an eye diagram width and a pre-emphasis parameter that is set in this process, and
calculating an initial value for the phase that is used when a right end and a left end of a phase range in which a number of errors that is calculated in this process is 0, on the basis of a right end and a left end that are calculated in the previous process and a comparison result.
